(19) United States
(12) Patent Application Publication
(10) Pub. No.: US 2024/0354962 A1
(43) Pub. Date: Oct. 24, 2024

(54) POSE OPTIMIZATION FOR OBJECT TRACKING

(71) Applicant: QUALCOMM Incorporated, San Diego, CA (US)

(72) Inventors: Robert Peter VIEHAUSER, Bad Hofgastein (AT); Markus EDER, Salzburg (AT)

(21) Appl. No.: 18/582,377

(22) Filed: Feb. 20, 2024

Related U.S. Application Data
(60) Provisional application No. 63/496,309, filed on Apr. 14, 2023.

(51) Int. Cl. G06T 7/20; G06T 7/70; G06T 17/00; G06V 10/44; G06V 10/75

(52) U.S. Cl. CPC G06T 7/20; G06T 7/70; G06T 17/00; G06V 10/44; G06V 10/751; G06T 2207/30168

(57) ABSTRACT

Systems and techniques are described herein for tracking objects. For instance, a method for tracking objects is provided. The method may include obtaining a pose of an object in a world coordinate system; obtaining an image of the object from a camera position; obtaining a world-to-camera transformation for relating the world coordinate system to the camera position; determining a reprojection error based on the pose of the object in the world coordinate system, the image, and the world-to-camera transformation; and adjusting the pose of the object in the world coordinate system based on the reprojection error.

### CROSS-REFERENCE TO RELATED APPLICATIONS

This application claims priority to U.S. Provisional Patent Application No. 63/496,309, filed Apr. 14, 2023, which is hereby incorporated by reference, in its entirety and for all purposes.

### TECHNICAL FIELD

The present disclosure generally relates to pose optimization for object tracking. For example, aspects of the present disclosure include systems and techniques for optimizing a pose of an object for object tracking based on multiple images of the object captured from multiple respective camera positions.

### BACKGROUND

An extended reality (XR) (e.g., virtual reality (VR), augmented reality (AR), and/or mixed reality (MR)) system may provide a user with a virtual experience by displaying virtual content at a display mostly, or entirely, filling a user's field of view or by displaying virtual content overlaid onto, or alongside, a user's field of view of the real world (e.g., using a see-through or pass-through display).

XR systems typically include a display (e.g., a head-mounted display (HMD) or smart glasses), an image-capture device proximate to the display, and a processing device. In such XR systems, the image-capture device may capture images indicative of a field of view of user, the processing device may generate virtual content based on the field of view of the user and/or objects within the field of view, and the display may display the virtual content within the field of view of the user.

In some cases, XR systems may track poses (including positions and orientations) of objects in the physical world (e.g., “real-world objects”). For example, an XR system may use images of real-world objects to calculate poses of the real-world objects. In some examples, the XR system may use the tracked poses of one or more respective real-world objects to render virtual content relative to the real-world objects in a convincing manner. For instance, such XR systems may use the pose information to match virtual content with a spatio-temporal state of the real-world objects. In one illustrative example, by tracking a real-world toy fire truck, an XR system may render a virtual fireman and display the virtual fireman in relation to (e.g., riding on) the real-world toy fire truck.

### BRIEF SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for tracking objects. According to at least one example, a method is provided for tracking objects. The method includes: obtaining a pose of an object in a world coordinate system [[ [symbol] ]]; obtaining an image of the object from a camera position; obtaining a world-to-camera transformation [[ [symbol] ]] for relating the world coordinate system to the camera position; determining a reprojection error based on the pose of the object in the world coordinate system [[ [symbol] ]], the image, and the world-to-camera transformation [[ [symbol] ]]; and adjusting the pose of the object in the world coordinate system [[ [symbol] ]] based on the reprojection error.

In another example, an apparatus for tracking objects is provided that includes at least one memory and at least one processor (e.g., configured in circuitry) coupled to the at least one memory. The at least one processor configured to: obtain a pose of an object in a world coordinate system [[ [symbol] ]]; obtain an image of the object from a camera position; obtain a world-to-camera transformation [[ [symbol] ]] for relating the world coordinate system to the camera position; determine a reprojection error based on the pose of the object in the world coordinate system [[ [symbol] ]], the image, and the world-to-camera transformation [[ [symbol] ]]; and adjust the pose of the object in the world coordinate system [[ [symbol] ]] based on the reprojection error.

In another example, a non-transitory computer-readable medium is provided that has stored thereon instructions that, when executed by one or more processors, cause the one or more processors to: obtain a pose of an object in a world coordinate system [[ [symbol] ]]; obtain an image of the object from a camera position; obtain a world-to-camera transformation [[ [symbol] ]] for relating the world coordinate system to the camera position; determine a reprojection error based on the pose of the object in the world coordinate system [[ [symbol] ]], the image, and the world-to-camera transformation [[ [symbol] ]]; and adjust the pose of the object in the world coordinate system [[ [symbol] ]] based on the reprojection error.

In another example, an apparatus for tracking objects is provided. The apparatus includes: means for obtaining a pose of an object in a world coordinate system [[ [symbol] ]]; means for obtaining an image of the object from a camera position; means for obtaining a world-to-camera transformation [[ [symbol] ]] for relating the world coordinate system to the camera position; means for determining a reprojection error based on the pose of the object in the world coordinate system [[ [symbol] ]], the image, and the world-to-camera transformation [[ [symbol] ]]; and means for adjusting the pose of the object in the world coordinate system [[ [symbol] ]] based on the reprojection error.

In some aspects, one or more of the apparatuses described herein is, can be part of, or can include a mobile device (e.g., a mobile telephone or so-called “smart phone”, a tablet computer, or other type of mobile device), an extended reality device (e.g., a virtual reality (VR) device, an augmented reality (AR) device, or a mixed reality (MR) device), a vehicle (or a computing device or system of a vehicle), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a diagram illustrating an example of an extended-reality (XR) system, according to aspects of the disclosure;

FIG. 2 is a diagram illustrating another example of an XR system, according to aspects of the disclosure;

FIG. 3 is a diagram illustrating an architecture of an example XR system, in accordance with some aspects of the disclosure;

FIG. 4 through FIG. 10 illustrate a system in which object may be tracked by XR device, according to various aspects of the present disclosure;

FIG. 11 illustrates a system in which two objects may be tracked by an XR device, according to various aspects of the present disclosure;

FIG. 12 illustrates locations of example features \hat{x}_{i,j} in a first image and corresponding locations of corresponding features x_{i,j} from a second image which may be used to calculate a reprojection error, according to various aspects of the present disclosure;

FIG. 13 is a flow diagram illustrating a process for optimizing a pose of an object, in accordance with aspects of the present disclosure;

FIG. 14 illustrates an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

As described above, an extended reality (XR) system or device may provide virtual content to a user and/or can combine real-world or physical environments and virtual environments (made up of virtual content) to provide users with XR experiences. The real-world environment can include real-world objects (also referred to as physical objects), such as people, vehicles, buildings, tables, chairs, and/or other real-world or physical objects. XR systems or devices can facilitate interaction with different types of XR environments (e.g., a user can use an XR system or device to interact with an XR environment). XR systems can include virtual reality (VR) systems facilitating interactions with VR environments, augmented reality (AR) systems facilitating interactions with AR environments, mixed reality (MR) systems facilitating interactions with MR environments, and/or other XR systems. Examples of XR systems or devices include head-mounted displays (HMDs), smart glasses, tablets, or smartphones among others. In some cases, an XR system can track parts of the user (e.g., a hand and/or fingertips of a user) to allow the user to interact with items of virtual content.

XR systems can include virtual reality (VR) systems facilitating interactions with VR environments, augmented reality (AR) systems facilitating interactions with AR environments, mixed reality (MR) systems facilitating interactions with MR environments, and/or other XR systems. For instance, VR provides a complete immersive experience in a three-dimensional (3D) computer-generated VR environment or video depicting a virtual version of a real-world environment. VR content can include VR video in some cases, which can be captured and rendered at very high quality, potentially providing a truly immersive virtual reality experience. Virtual reality applications can include gaming, training, education, sports video, online shopping, among others. VR content can be rendered and displayed using a VR system or device, such as a VR HMD or other VR headset, which fully covers a user's eyes during a VR experience.

AR is a technology that provides virtual or computer-generated content (referred to as AR content) over the user's view of a physical, real-world scene or environment. AR content can include any virtual content, such as video, images, graphic content, location data (e.g., global positioning system (GPS) data or other location data), sounds, any combination thereof, and/or other augmented content. An AR system is designed to enhance (or augment), rather than to replace, a person's current perception of reality. For example, a user can see a real stationary or moving physical object through an AR device display, but the user's visual perception of the physical object may be augmented or enhanced by a virtual image of that object (e.g., a real-world car replaced by a virtual image of a DeLorean), by AR content added to the physical object (e.g., virtual wings added to a real-world pig), by AR content displayed relative to the physical object (e.g., informational virtual content displayed near a sign on a building, a virtual monster anchored to (e.g., placed on top of) a real-world table in one or more images, etc.), and/or by displaying other types of AR content. Various types of AR systems can be used for gaming, entertainment, and/or other applications.

MR technologies can combine aspects of VR and AR to provide an immersive experience for a user. For example, in an MR environment, real-world and computer-generated objects can interact (e.g., a real person can interact with a virtual person as if the virtual person were a real person). Additionally, or alternatively, MR can include a VR headset with AR capabilities, for instance, an MR system may perform video pass-through (to mimic AR glasses) by passing images (and/or video) of some real-world objects, like a keyboard and/or a monitor, and/or taking real-word geometry (e.g., walls, tables) into account. For example, in a game, the structure of a room can be retextured to according to the game, but the geometry may still be based on the real-world geometry of the room.

In some cases, an XR system can include an optical “see-through” or “pass-through” display (e.g., see-through or pass-through AR HMD or AR glasses), allowing the XR system to display XR content (e.g., AR content) directly onto a real-world view without displaying video content. For example, a user may view physical objects through a display (e.g., glasses or lenses), and the AR system can display AR content onto the display to provide the user with an enhanced visual perception of one or more real-world objects. In one example, a display of an optical see-through AR system can include a lens or glass in front of each eye (or a single lens or glass over both eyes). The see-through display can allow the user to see a real-world or physical object directly, and can display (e.g., projected or otherwise displayed) an enhanced image of that object or additional AR content to augment the user's visual perception of the real world.

XR systems or devices can facilitate interaction with different types of XR environments (e.g., a user can use an XR system or device to interact with an XR environment). One example of an XR environment is a metaverse virtual environment. A user may virtually interact with other users (e.g., in a social setting, in a virtual meeting, etc.), virtually shop for items (e.g., goods, services, property, etc.), to play computer games, and/or to experience other services in a metaverse virtual environment. In one illustrative example, an XR system may provide a 3D collaborative virtual environment for a group of users. The users may interact with one another via virtual representations of the users in the virtual environment. The users may visually, audibly, haptically, or otherwise experience the virtual environment while interacting with virtual representations of the other users.

An XR environment can be interacted with in a seemingly real or physical way. As a user experiencing an XR environment (e.g., an immersive VR environment) moves in the real world, rendered virtual content (e.g., images rendered in a virtual environment in a VR experience) also changes, giving the user the perception that the user is moving within the XR environment. For example, a user can turn left or right, look up or down, and/or move forwards or backwards, thus changing the user's point of view of the XR environment. The XR content presented to the user can change accordingly, so that the user's experience in the XR environment is as seamless as it would be in the real world.

In order to provide and/or display virtual content, XR systems may track the XR system and/or real-world object. Degrees of freedom (DoF) refer to the number of basic ways a rigid object can move through three-dimensional (3D) space. In some cases, XR systems and/or real-world object can be tracked through six different DoF. The six degrees of freedom include three translational degrees of freedom corresponding to translational movement along three perpendicular axes. The three axes can be referred to as x, y, and z axes. The six degrees of freedom include three rotational degrees of freedom corresponding to rotational movement around the three axes, which can be referred to as roll pitch, and yaw.

In the context of systems that track movement through an environment, such as XR systems, degrees of freedom can refer to which of the six degrees of freedom the system is capable of tracking. 3DoF systems generally track the three rotational DoF—pitch, yaw, and roll. A 3DoF headset, for instance, can track the user of the headset turning their head left or right, tilting their head up or down, and/or tilting their head to the left or right. 6DoF systems can track the three translational DoF as well as the three rotational DoF. Thus, a 6DoF headset, for instance, can track the user moving forward, backward, laterally, and/or vertically in addition to tracking the three rotational DoF.

An XR system may track changes in pose (e.g., changes in translations and changes of orientation, including changes in roll, pitch, and/or yaw) of respective elements of the XR system (e.g., a display and/or a camera of the XR system) in six DoF. In the present disclosure, the term “pose,” and like terms, may refer to position and orientation (including roll, pitch, and yaw). The XR system may relate the poses (e.g., including position and orientation, where orientation can include roll, pitch, and yaw) of the respective elements of the XR system to a reference coordinate system (which may alternatively be referred to has a world coordinate system). The reference coordinate system may be stationary and may be associated with the real-world environment in which the XR system is being used. Tracking the poses of the elements of the XR system relative to the reference coordinate system may allow virtual content to be displayed accurately relative to the real-world environment. For example, by tracking a display of the XR system, the XR system may be able to position virtual content in the display, as the display changes pose, such that the virtual content remains stationary in the field of view of a viewer of the display.

In some cases, a display of an XR system (e.g., an AMD, AR glasses, etc.) may include one or more inertial measurement units (IMUs) and may use measurements from the IMUs determine a pose of the display. Based on the determined pose, the XR system may generate and/or display virtual content. The XR system may change the location of the virtual content on the display as the display changes pose such that the virtual content maintains correspondence to the real-world position (e.g., between the user's eye and the real-world position) despite the display changing pose.

Further some XR systems may use visual simultaneous localization and mapping (VSLAM which may also be referred to as simultaneous localization and mapping (SLAM)) computational-geometry techniques to track a pose of an element (e.g., a display) of such XR systems. In VSLAM, a device can construct and update a map of an unknown environment based on images captured by the device's camera. The device can keep track of the device's pose within the environment (e.g., location and/or orientation) as the device updates the map. For example, the device can be activated in a particular room of a building and can move throughout the interior of the building, capturing images. The device can map the environment, and keep track of its location in the environment, based on tracking where different objects in the environment appear in different images.

Thus, an XR system may track the pose (e.g., in six DoF) of a display of the XR system (which may be coupled to a camera of the XR system) in the reference coordinate system using data from IMUs and/or SLAM techniques. Tracking the pose of the display may allow the XR system to display virtual content relative to the real world.

Additionally, as described above, in some cases, XR systems may track poses of objects in the physical world (e.g., “real-world objects”). For example, an XR system may use images of real-world objects to calculate poses of the real-world objects. In some examples, the XR system may use the tracked poses of one or more respective real-world objects to render virtual content relative to the real-world objects in a convincing manner. For example, such XR systems may use the pose information to match virtual content with the spatio-temporal state of the real-world objects. For example, by tracking a real-world toy fire truck, an XR system may render a virtual fireman and display the virtual fireman in relation to (e.g., riding on) the real-world toy fire truck. In some examples, XR systems may track other objects for other purposes. For example, an XR system may track hands of a user to allow the user to interact with virtual content based on the position of the user's hands.

Object tracking, specifically object tracking using XR systems includes challenging problems. For example, many XR systems include cameras with a large field of view (e.g., optimized for world tracking). Such cameras may capture objects using fewer pixels than would be used to capture the objects using cameras with a smaller field of view. Additionally, or alternatively, such cameras may distort the objects in captured images.

Systems, apparatuses, processes (also referred to as methods), and computer-readable media (collectively referred to as “systems and techniques”) are described herein for performing pose optimization for object tracking. In some aspects, the systems and techniques may obtain images of an object and optimize a pose of the object based on the images. For example the systems and techniques may obtain a pose of the object in the world coordinate system ( [symbol] ). Then, based on images of the object (from different camera positions) the systems and techniques may optimize the pose of the object in the world coordinate system ( [symbol] ).

The systems and techniques may leverage the world-tracking operations of an XR system. For example, some XR systems may include an “always on” world tracker, tracking the world (or the XR system within the world) in six DoF. The systems and techniques may use this tracking to obtain world-to-camera transformations ( [symbol] ). In some cases, based on an image of an object, the systems and techniques may determine the pose of the object in the world coordinate system ( [symbol] ) using the world-to-camera transformations ( [symbol] ). Whether the systems and techniques determine the pose of the object in the world coordinate system ( [symbol] ) using the world-to-camera transformations ( [symbol] ) or not, the systems and techniques may use the world-to-camera transformations ( [symbol] ) in optimizing the pose of the object in the world coordinate system ( [symbol] ). For example, when optimizing the pose of the object in the world coordinate system ( [symbol] ), the systems and techniques may determine world-to-camera transformations ( [symbol] ) for each of the different camera positions from which the images of the object are captured and use the world-to-camera transformations ( [symbol] ) in optimizing the pose of the object in the world coordinate system ( [symbol] ).

Some techniques for pose determination may include determining a pose of an object in a camera coordinate system at regular intervals (e.g., based on every captured image frame). For example, every time a camera of an XR system (which is coupled to a display of the XR system) captures an image (e.g., at a rate of 30 frames per second), the XR system may determine a pose of an object in the image in a coordinate system of the camera ( [symbol] ). The XR system may determine the pose ( [symbol] ) by identifying features of the object and comparing the locations of the features of the object (\hat{x}ᵢ) to the locations of corresponding features on a model of the object (xᵢ). For example. such techniques may adjust pose parameters (ω₀^{c}) of the pose ( [symbol] ) in a way such that the sum of the (squared) reprojection error (i.e., the distance between a projected point (\hat{x}ᵢ) and visually corresponding point (xᵢ)) is minimized. For example, such techniques may operate according to:

$${arg min}_{{ω}_{o}^{c}} {\sum }_{i} {( {x}_{i} - {\hat{x}}_{i} )}^{2}$$

Such techniques may be computationally expensive (e.g., in terms of time and/or power consumption). For example, such techniques may include relatively complex operations for every image (e.g., each frame).

The systems and techniques described herein may obtain a pose of the object in a world coordinate system, then optimize the pose of the object in the world coordinate system. Optimizing the pose of the object in the world coordinate system may be less computationally expensive (e.g., in terms of time and/or power consumption) than determining the pose in the camera coordinate system. For example, the optimization problem may be simpler (e.g., computationally) to solve than the pose-determination problem.

The systems and techniques may adjust the pose parameters of the object in a world coordinate system (ω₀^{w}) in a way such that the sum of the (squared) reprojection error (difference between projected point (\hat{x}_{i,j}) and visual correspondence (x_{i,j})) over multiple views (indexed by j) is minimized. For example, the systems and techniques may operate according to:

$${arg min}_{{ω}_{o}^{w}} {\sum }_{j} {\sum }_{i} {( {x}_{i , j} - {\hat{x}}_{i , j} )}^{2}$$

This can be done, because all views share the same transformation [symbol] when the object is not moving relative to the world.

The systems and techniques may obtain a pose of the object in the world coordinate system ( [symbol] ). Then, the systems and techniques may optimize the pose of the object in the world coordinate system ( [symbol] ). The pose of the object in the world coordinate system ( [symbol] ) may be determined based on one or more of: a plurality of images from a respective plurality of cameras, a predetermined alignment, an automatic alignment (e.g., based on quick response (QR) code recognition, or a deep-learning pose-recognition technique).

As an example of obtaining the pose of the object in the world coordinate system ( [symbol] ), the systems and techniques may obtain a first image of an object, the first image captured from a first camera position. The systems and techniques may determine a pose of the object in a camera coordinate system ( [symbol] ) based on the first image of the object and the first camera position. The pose of the object in the camera coordinate system may be, or may include, a position of the object relative to the first camera position and an orientation of the object.

Continuing the example, the systems and techniques may obtain a first world-to-camera transformation ( [symbol] ) for relating a world coordinate system to the first camera position. The world-to-camera transformation ( [symbol] ) may be determined based on data from the IMUs and/or the SLAM technique. The systems and techniques may determine a pose of the object in the world coordinate system ( [symbol] ) based on the pose of the object in the camera coordinate system ( [symbol] ) and the first world-to-camera transformation ( [symbol] ).

After obtaining the pose of the object in the world coordinate system ( [symbol] ) (either by determining the pose of the object in the world coordinate system ( [symbol] ) based on an image or through some other technique), the systems and techniques may optimize the pose of the object in the world coordinate system ( [symbol] ). The systems and techniques may obtain an image of the object from a camera position and obtain a world-to-camera transformation ( [symbol] ) for relating the world coordinate system to the camera position. The systems and techniques may optimize the previously-obtained pose of the object in the world coordinate system ( [symbol] ) based on the image and the world-to-camera transformation ( [symbol] ).

For example, the systems and techniques may reproject, based on the world-to-camera transformation ( [symbol] ), a model of the object in the pose of the object in the world coordinate system (ωₒ^{w}) into an image plane based on the camera position. The model of the object may be a point-cloud model of the object, a computer-aided design (CAD) model of the object, and/or a neural radiance field. The systems and techniques may identify features of the object based on (e.g., based on the model of the object). The features may be visually distinctive portions of the object. The systems and techniques may determine a reprojection error based on comparing locations of the features of the object in the second image (x_{i,j}) with locations of the features of the object (\hat{x}_{i,j}) in the reprojection of the model of the object in the pose of the object in the world coordinate system ( [symbol] ) into the image plane of the camera position

Systems and techniques may allow for lower power consumption compared to high frame per second (FPS) tracking. For example, optimizing the pose of the object in the world coordinate system ( [symbol] ) may be computationally less complex (e.g., requiring fewer and/or simpler operations) than calculating or adjusting pose parameters (ωₒ^{c}) for a single frame at a high frame rate. There may be no real time constraints on pose estimation per frame. Thus, pose optimization may run in a background thread. Running in the background may be advantageous when a number of objects within a scene are all to be tracked.

Further, systems and techniques may allow for high registration accuracy. For example, one single pose estimation may be distributed over several frames and viewpoints. Further, systems and techniques may allow for corrective object-to-world registration. For example, when an object is slightly moved, or the world pose and/or the initial object-to-world pose are inaccurate, the systems and techniques may automatically adjust the object-to-world pose.

Further, systems and techniques may allow for higher perceived tracking distance. For example, pose calculation from distributed measurements (e.g., from multiple images) does not require the high amount or quality of visual measurements a pose estimation from a single frame would require.

In some cases, the systems and techniques may optimize the pose of the object every time a frame is captured e.g., matching a frame-capture rate of a camera of the XR device. In other cases, the systems and techniques may optimize the pose of the object at other intervals. For example, a camera of the XR system may capture frames continuously (e.g., at 30 frames per second). The systems and techniques may optimize poses of the object at a rate of 6 times per second. For example, the systems and techniques may select every sixth image (e.g., based on a timestamp of the images or the series of images) and optimize the pose based on the selected images.

Systems and techniques may further include dynamic workload adjustments. For example, based on determined motion and/or measurement quality metrics, the systems and techniques can gradually adjust the measurement and pose update frequency from almost idle to high FPS, single frame tracking. For example, the systems and techniques may determine how often to update a pose of the object based on motion of the object, motion of the display, and/or quality parameters. For example, if the object is stationary, the systems and techniques may infrequently update the object pose. However, if the object begins to move, the systems and techniques may determine to update the object pose more frequently.

The systems and techniques may determine when an object is mostly stationary. Mostly stationary may mean that an object may not move more than a threshold amount between frames. For example, systems and techniques may determine a first position of an object at a first time and a second position of the object at a second time and determine a motion state of the object based on the difference between the first position and the second position. The motion state may be one of: stationary, mostly stationary, slowly moving, moving, quickly moving, etc. The systems and techniques may determine how frequently to optimize a pose of the object based on the motion state of the object. Additionally, or alternatively, the systems and techniques may determine a motion state of the object based on a categorization of the object. For example, the systems and techniques may categorize the object (e.g., using an object recognition algorithm).

Further distributed measurements (e.g., images) may also be spatially distributed and/or temporally distributed. For example, systems and techniques may operate across multiple devices in a multi-user/multi-camera setup. Visual measurements can be transferred from another user device which might be closer to the object or sees the object from a different view angle. The measurements can be used to estimate the object-to-world pose. For example, rather than the camera moving and capturing images from different positions, multiple cameras in multiple positions, may capture images and the systems and techniques may operate thereon.

Systems and techniques may perform grouping of multiple objects. For example, to further increase efficiency in multi-target scenarios, almost static objects can be treated as a single object. This enables tracking of multiple objects with only one pose estimation problem per group, and thus, beside more efficient computation, also fewer required measurements per object. Groups can be dynamically formed or released, depending on the determined motion of single objects and/or object measurements.

Regarding notation: a pose/transformation matrix, [symbol] generally includes a 4×4 matrix used to change a frame of reference of 3D coordinates from system “1” to system “2.” Further, pose parameters of include 6 parameters that define [symbol] = [symbol] (ω₁²). \hat{x}ᵢ represents projected 2D point of a known point on the object to the camera image based on a given [symbol] , with index i. xᵢ represents a 2D point in an image, which is the found visual correspondence with known point on the object of index i.

The systems and techniques may apply to objects and object tracking. Additionally, or alternatively, the systems and techniques may apply to images and image tracking. For example, instead of tracking objects, that systems and techniques may track images (e.g., printed images). As such, references herein to “objects” may refer to images.

Various aspects of the application will be described with respect to the figures below.

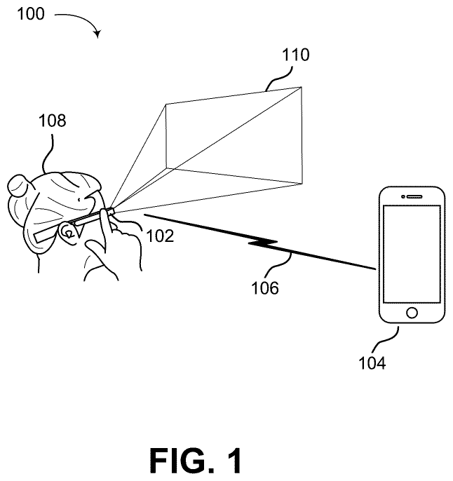

FIG. 1 is a diagram illustrating an example of an extended-reality (XR) system 100, according to aspects of the disclosure. As shown, XR system 100 includes an XR device 102, a companion device 104, and a communication link 106 between XR device 102 and companion device 104. In some cases, XR device 102 may generally implement display, image-capture, and/or view-tracking aspects of extended reality, including virtual reality (VR), augmented reality (AR), mixed reality (MR), etc. In some cases, companion device 104 may generally implement computing aspects of extended reality. For example, XR device 102 may capture images of an environment of a user 108 and provide the images to companion device 104 (e.g., via communication link 106). Companion device 104 may render virtual content (e.g., related to the captured images of the environment) and provide the virtual content to XR device 102 (e.g., via communication link 106). XR device 102 may display the virtual content to a user 108 (e.g., within a field of view 110 of user 108).

Generally, XR device 102 may display virtual content to be viewed by a user 108 in field of view 110. In some examples, XR device 102 may include a transparent surface (e.g., optical glass) such that virtual objects may be displayed on (e.g., by being generated at or projected onto) the transparent surface to overlay virtual content on real-word objects viewed through the transparent surface (e.g., in a see-through configuration). In some cases, XR device 102 may include a camera and may display both real-world objects (e.g., as frames or images captured by the camera) and virtual objects overlaid on the displayed real-world objects (e.g., in a pass-through configuration). In various examples, XR device 102 may include aspects of a virtual reality headset, smart glasses, a live feed video camera, a GPU, one or more sensors (e.g., such as one or more inertial measurement units (IMUs), image sensors, microphones, etc.), one or more output devices (e.g., such as speakers, display, smart glass, etc.), etc.

Companion device 104 may render the virtual content to be displayed by companion device 104. In some examples, companion device 104 may be, or may include, a smartphone, laptop, tablet computer, personal computer, gaming system, a server computer or server device (e.g., an edge or cloud-based server, a personal computer acting as a server device, or a mobile device acting as a server device), any other computing device and/or a combination thereof.

Communication link 106 may be a wired or wireless connection according to any suitable wireless protocol, such as, for example, universal serial bus (USB), ultra-wideband (UWB), Institute of Electrical and Electronics Engineers (IEEE) 802.11 (Wi-Fi), IEEE 802.15, or Bluetooth®. In some cases, communication link 106 may be a direct wireless connection between XR device 102 and companion device 104. In other cases, communication link 106 may be through one or more intermediary devices, such as, for example, routers or switches and/or across a network.

According to various aspects, XR device 102 may capture images and provide the captured images to companion device 104. Companion device 104 may implement detection, recognition, and/or tracking algorithms based on the captured images.

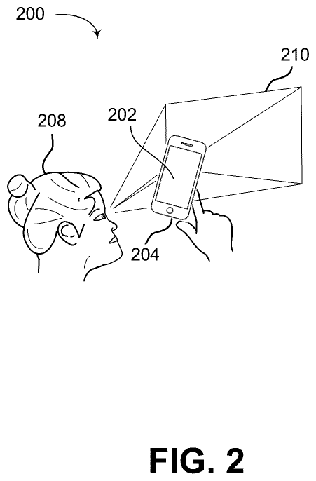

FIG. 2 is a diagram illustrating an example of an extended-reality (XR) system 200, according to aspects of the disclosure. As shown, XR system 200 includes an XR device 204 including a display 202. In some cases, XR device 204 may generally implement display, image-capture, view-tracking, and/or computational aspects of extended reality, including virtual reality (VR), augmented reality (AR), mixed reality (MR), etc. For example, XR device 204 may capture images of an environment of a user 208, render virtual content (e.g., related to the captured images of the environment), and display the virtual content to a user 208 (e.g., within a field of view 210 of user 208).

Generally, XR device 204 may display virtual content to be viewed by a user 208 in field of view 210. In some examples, XR device 204 may include a display 202 to be placed within field of view 210 of user 208. XR device 204 and/or display 202 may take the form of a head-mounted display (HMID), a smartphone, a tablet, or another computing device with a display. In some cases, XR device 204 may include a camera and may display both real-world objects (e.g., as frames or images captured by the camera) and virtual objects overlaid on the displayed real-world objects (e.g., in a pass-through configuration). In various examples, XR device 204 may include aspects of a virtual reality headset, smart glasses, a live feed video camera, a GPU, one or more sensors (e.g., such as one or more inertial measurement units (IMUs), image sensors, microphones, etc.), one or more output devices (e.g., such as speakers, display, smart glass, etc.), etc. XR device 204 may implement detection, recognition, and/or tracking algorithms based on the captured images.

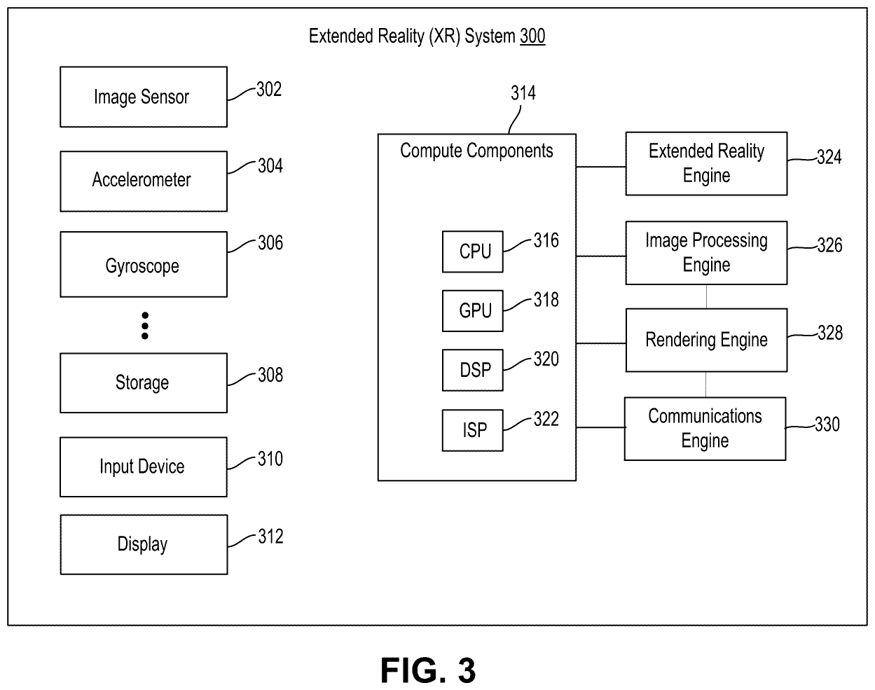

FIG. 3 is a diagram illustrating an architecture of an example extended reality (XR) system 300, in accordance with some aspects of the disclosure. XR system 300 may execute XR applications and implement XR operations.

In this illustrative example, XR system 300 includes one or more image sensors 302, an accelerometer 304, a gyroscope 306, storage 308, an input device 310, a display 312, compute components 314, an XR engine 324, an image processing engine 326, a rendering engine 328, and a communications engine 330. It should be noted that the components 302-330 shown in FIG. 3 are non-limiting examples provided for illustrative and explanation purposes, and other examples may include more, fewer, or different components than those shown in FIG. 3. For example, in some cases, XR system 300 may include one or more other sensors (e.g., one or more inertial measurement units (IMUs), radars, light detection and ranging (LIDAR) sensors, radio detection and ranging (RADAR) sensors, sound detection and ranging (SODAR) sensors, sound navigation and ranging (SONAR) sensors, audio sensors, etc.), one or more display devices, one more other processing engines, one or more other hardware components, and/or one or more other software and/or hardware components that are not shown in FIG. 3. While various components of XR system 300, such as image sensor 302, may be referenced in the singular form herein, it should be understood that XR system 300 may include multiple of any component discussed herein (e.g., multiple image sensors 302).

Display 312 may be, or may include, a glass, a screen, a lens, a projector, and/or other display mechanism that allows a user to seethe real-world environment and also allows XR content to be overlaid, overlapped, blended with, or otherwise displayed thereon.

XR system 300 may include, or may be in communication with, (wired or wirelessly) an input device 310. Input device 310 may include any suitable input device, such as a touchscreen, a pen or other pointer device, a keyboard, a mouse a button or key, a microphone for receiving voice commands, a gesture input device for receiving gesture commands, a video game controller, a steering wheel, a joystick, a set of buttons, a trackball, a remote control, any other input device discussed herein, or any combination thereof. In some cases, image sensor 302 may capture images that may be processed for interpreting gesture commands.

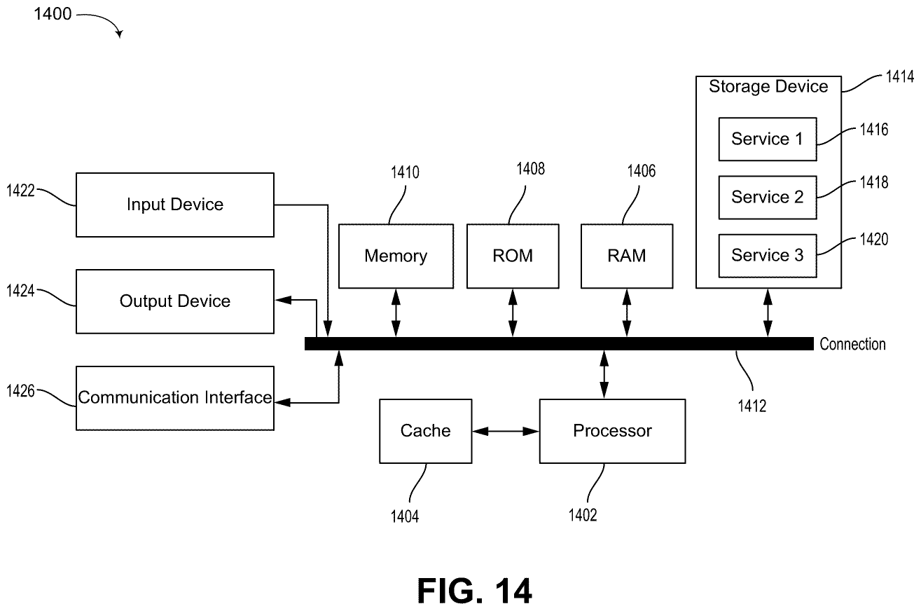

XR system 300 may also communicate with one or more other electronic devices (wired or wirelessly). For example, communications engine 330 may be configured to manage connections and communicate with one or more electronic devices. In some cases, communications engine 330 may correspond to communication interface 1426 of FIG. 14.

In some implementations, image sensors 302, accelerometer 304, gyroscope 306, storage 308, display 312, compute components 314, XR engine 324, image processing engine 326, and rendering engine 328 may be part of the same device. For example, in some cases, image sensors 302, accelerometer 304, gyroscope 306, storage 308, display 312, compute components 314, XR engine 324, image processing engine 326, and rendering engine 328 may be integrated into an HMD, extended reality glasses, smartphone, laptop, tablet computer, gaming system, and/or any other computing device (e.g., XR device 204 of FIG. 2). However, in some implementations, image sensors 302, accelerometer 304, gyroscope 306, storage 308, display 312, compute components 314, XR engine 324, image processing engine 326, and rendering engine 328 may be part of two or more separate computing devices. For instance, in some cases, some of the components 302-330 may be part of, or implemented by, one computing device and the remaining components may be part of, or implemented by, one or more other computing devices. For example, such as in a split perception XR system, XR system 300 may include a first device (e.g., an XR device such as XR device 102 of FIG. 1), including display 312, image sensor 302, accelerometer 304, gyroscope 306, and/or one or more compute components 314. XR system 300 may also include a second device including additional compute components 314 (e.g., implementing XR engine 324, image processing engine 326, rendering engine 328, and/or communications engine 330). In such an example, the second device may generate virtual content based on information or data (e.g., images, sensor data such as measurements from accelerometer 304 and gyroscope 306) and may provide the virtual content to the first device for display at the first device. The second device may be, or may include, a smartphone, laptop, tablet computer, personal computer, gaming system, a server computer or server device (e.g., an edge or cloud-based server, a personal computer acting as a server device, or a mobile device acting as a server device), any other computing device and/or a combination thereof.

Storage 308 may be any storage device(s) for storing data. Moreover, storage 308 may store data from any of the components of XR system 300. For example, storage 308 may store data from image sensor 302 (e.g., image or video data), data from accelerometer 304 (e.g., measurements), data from gyroscope 306 (e.g., measurements), data from compute components 314 (e.g., processing parameters, preferences, virtual content, rendering content, scene maps, tracking and localization data, object detection data, privacy data, XR application data, face recognition data, occlusion data, etc.), data from XR engine 324, data from image processing engine 326, and/or data from rendering engine 328 (e.g., output frames). In some examples, storage 308 may include a buffer for storing frames for processing by compute components 314.

Compute components 314 may be, or may include, a central processing unit (CPU) 316, a graphics processing unit (GPU) 318, a digital signal processor (DSP) 320, an image signal processor (ISP) 322, and/or other processor (e.g., a neural processing unit (NPU) implementing one or more trained neural networks). Compute components 314 may perform various operations such as image enhancement, computer vision, graphics rendering, extended reality operations (e.g., tracking, localization, pose estimation, mapping, content anchoring, content rendering, predicting, etc.), image and/or video processing, sensor processing, recognition (e.g., text recognition, facial recognition, object recognition, feature recognition, tracking or pattern recognition, scene recognition, occlusion detection, etc.), trained machine-learning operations, filtering, and/or any of the various operations described herein. In some examples, compute components 314 may implement (e.g., control, operate, etc.) XR engine 324, image processing engine 326, and rendering engine 328. In other examples, compute components 314 may also implement one or more other processing engines.

Image sensor 302 may include any image and/or video sensors or capturing devices. In some examples, image sensor 302 may be part of a multiple-camera assembly, such as a dual-camera assembly. Image sensor 302 may capture image and/or video content (e.g., raw image and/or video data), which may then be processed by compute components 314, XR engine 324, image processing engine 326, and/or rendering engine 328 as described herein.

In some examples, image sensor 302 may capture image data and may generate images (also referred to as frames) based on the image data and/or may provide the image data or frames to XR engine 324, image processing engine 326, and/or rendering engine 328 for processing. An image or frame may include a video frame of a video sequence or a still image. An image or frame may include a pixel array representing a scene. For example, an image may be a red-green-blue (RGB) image having red, green, and blue color components per pixel; a luma, chroma-red, chroma-blue (YCbCr) image having a luma component and two chroma (color) components (chroma-red and chroma-blue) per pixel; or any other suitable type of color or monochrome image.

In some cases, image sensor 302 (and/or other camera of XR system 300) may be configured to also capture depth information. For example, in some implementations, image sensor 302 (and/or other camera) may include an RGB-depth (RGB-D) camera. In some cases, XR system 300 may include one or more depth sensors (not shown) that are separate from image sensor 302 (and/or other camera) and that may capture depth information. For instance, such a depth sensor may obtain depth information independently from image sensor 302. In some examples, a depth sensor may be physically installed in the same general location or position as image sensor 302 but may operate at a different frequency or frame rate from image sensor 302. In some examples, a depth sensor may take the form of a light source that may project a structured or textured light pattern, which may include one or more narrow bands of light, onto one or more objects in a scene. Depth information may then be obtained by exploiting geometrical distortions of the projected pattern caused by the surface shape of the object. In one example, depth information may be obtained from stereo sensors such as a combination of an infra-red structured light projector and an infra-red camera registered to a camera (e.g., an RGB camera).

XR system 300 may also include other sensors in its one or more sensors. The one or more sensors may include one or more accelerometers (e.g., accelerometer 304), one or more gyroscopes (e.g., gyroscope 306), and/or other sensors. The one or more sensors may provide velocity, orientation, and/or other position-related information to compute components 314. For example, accelerometer 304 may detect acceleration by XR system 300 and may generate acceleration measurements based on the detected acceleration. In some cases, accelerometer 304 may provide one or more translational vectors (e.g., up/down, left/right, forward/back) that may be used for determining a position or pose of XR system 300. Gyroscope 306 may detect and measure the orientation and angular velocity of XR system 300. For example, gyroscope 306 may be used to measure the pitch, roll, and yaw of XR system 300. In some cases, gyroscope 306 may provide one or more rotational vectors (e.g., pitch, yaw, roll). In some examples, image sensor 302 and/or XR engine 324 may use measurements obtained by accelerometer 304 (e.g., one or more translational vectors) and/or gyroscope 306 (e.g., one or more rotational vectors) to calculate the pose of XR system 300. As previously noted, in other examples, XR system 300 may also include other sensors, such as an inertial measurement unit (IMU), a magnetometer, a gaze and/or eye tracking sensor, a machine vision sensor, a smart scene sensor, a speech recognition sensor, an impact sensor, a shock sensor, a position sensor, a tilt sensor, etc.

As noted above, in some cases, the one or more sensors may include at least one IMU. An IMU is an electronic device that measures the specific force, angular rate, and/or the orientation of XR system 300, using a combination of one or more accelerometers, one or more gyroscopes, and/or one or more magnetometers. In some examples, the one or more sensors may output measured information associated with the capture of an image captured by image sensor 302 (and/or other camera of XR system 300) and/or depth information obtained using one or more depth sensors of XR system 300.

The output of one or more sensors (e.g., accelerometer 304, gyroscope 306, one or more IMUs, and/or other sensors) can be used by XR engine 324 to determine a pose of XR system 300 (also referred to as the head pose) and/or the pose of image sensor 302 (or other camera of XR system 300). In some cases, the pose of XR system 300 and the pose of image sensor 302 (or other camera) can be the same. The pose of image sensor 302 refers to the position and orientation of image sensor 302 relative to a frame of reference (e.g., with respect to a field of view 110 of FIG. 1). In some implementations, the camera pose can be determined for 6-Degrees of Freedom (6DoF), which refers to three translational components (e.g., which can be given by X (horizontal), Y (vertical), and Z (depth) coordinates relative to a frame of reference, such as the image plane) and three angular components (e.g., roll, pitch, and yaw relative to the same frame of reference). In some implementations, the camera pose can be determined for 3-Degrees of Freedom (3DoF), which refers to the three angular components (e.g., roll, pitch, and yaw).

In some cases, a device tracker (not shown) can use the measurements from the one or more sensors and image data from image sensor 302 to track a pose (e.g., a 6DoF pose) of XR system 300. For example, the device tracker can fuse visual data (e.g., using a visual tracking solution) from the image data with inertial data from the measurements to determine a position and motion of XR system 300 relative to the physical world (e.g., the scene) and a map of the physical world. As described below, in some examples, when tracking the pose of XR system 300, the device tracker can generate a three-dimensional (3D) map of the scene (e.g., the real world) and/or generate updates for a 3D map of the scene. The 3D map updates can include, for example and without limitation, new or updated features and/or feature or landmark points associated with the scene and/or the 3D map of the scene, localization updates identifying or updating a position of XR system 300 within the scene and the 3D map of the scene, etc. The 3D map can provide a digital representation of a scene in the real/physical world. In some examples, the 3D map can anchor position-based objects and/or content to real-world coordinates and/or objects. XR system 300 can use a mapped scene (e.g., a scene in the physical world represented by, and/or associated with, a 3D map) to merge the physical and virtual worlds and/or merge virtual content or objects with the physical environment.

In some aspects, the pose of image sensor 302 and/or XR system 300 as a whole can be determined and/or tracked by compute components 314 using a visual tracking solution based on images captured by image sensor 302 (and/or other camera of XR system 300). For instance, in some examples, compute components 314 can perform tracking using computer vision-based tracking, model-based tracking, and/or simultaneous localization and mapping (SLAM) techniques. For instance, compute components 314 can perform SLAM or can be in communication (wired or wireless) with a SLAM system (not shown). SLAM refers to a class of techniques where a map of an environment (e.g., a map of an environment being modeled by XR system 300) is created while simultaneously tracking the pose of a camera (e.g., image sensor 302) and/or XR system 300 relative to that map. The map can be referred to as a SLAM map and can be three-dimensional (3D). The SLAM techniques can be performed using color or grayscale image data captured by image sensor 302 (and/or other camera of XR system 300) and can be used to generate estimates of 6DoF pose measurements of image sensor 302 and/or XR system 300. Such a SLAM technique configured to perform 6DoF tracking can be referred to as 6DoF SLAM. In some cases, the output of the one or more sensors (e.g., accelerometer 304, gyroscope 306, one or more IMUs, and/or other sensors) can be used to estimate, correct, and/or otherwise adjust the estimated pose.

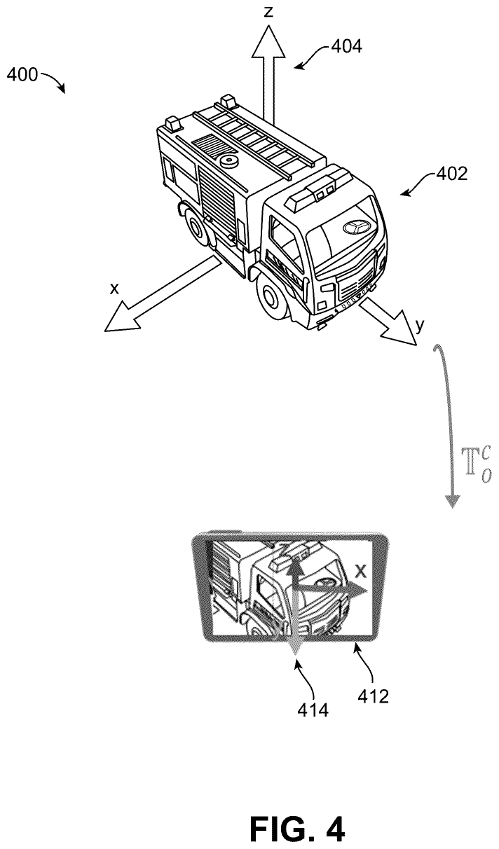

FIG. 4 illustrates a system 400 in which an object 402 may be tracked by an XR device 412, according to various aspects of the present disclosure. Object 402 may be any suitable object that may be tracked by XR device 412. Object 402 is illustrated as a toy fire truck as an example. Object 402 may be tracked according to an object coordinate system 404. Object coordinate system 404 may be centered on object 402 and may translate and reorient with object 402.

XR device 412 may be any suitable XR device. XR device includes a display and a camera. XR device 412 may be tracked according to a camera coordinate system 414. Camera coordinate system 414 may be centered on XR device 412 and may translate and reorient with XR device 412.

[symbol] represents a transformation between object coordinate system 404 and camera coordinate system 414. [symbol] is a transformation matrix (e.g., a 4×4 matrix) used to change the frame of reference of 3D coordinates from object coordinate system 404 to camera coordinate system 414. Tracking (e.g., object tracking) may include finding the transformation from object to camera ( [symbol] ).

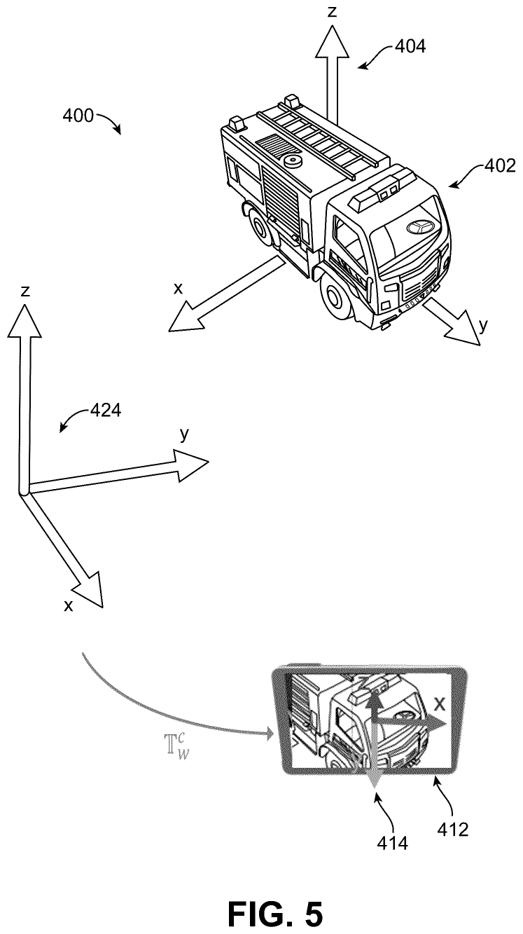

FIG. 5 illustrates system 400 in which object 402 may be tracked by XR device 412, according to various aspects of the present disclosure. FIG. 5 adds to system 400 by illustrating world coordinate system 424. World coordinate system 424 may be a reference coordinate system. World coordinate system 424 may be stationary. World coordinate system 424 may correspond to the environment of object 402 and XR device 412. XR device 412 may track world coordinate system 424 using SLAM and/or IMUs. In other words, XR device 412 may determine its position (in six DoF) relative to world coordinate system 424.

XR device 412 may determine a world-to-camera transformation ( [symbol] ) for relating a world coordinate system to the first camera position. [symbol] represents a transformation between world coordinate system 424 and camera coordinate system 414. [symbol] is a transformation matrix (e.g., a 4×4 matrix) used to change the frame of reference of 3D coordinates from world coordinate system 424 to camera coordinate system 414.

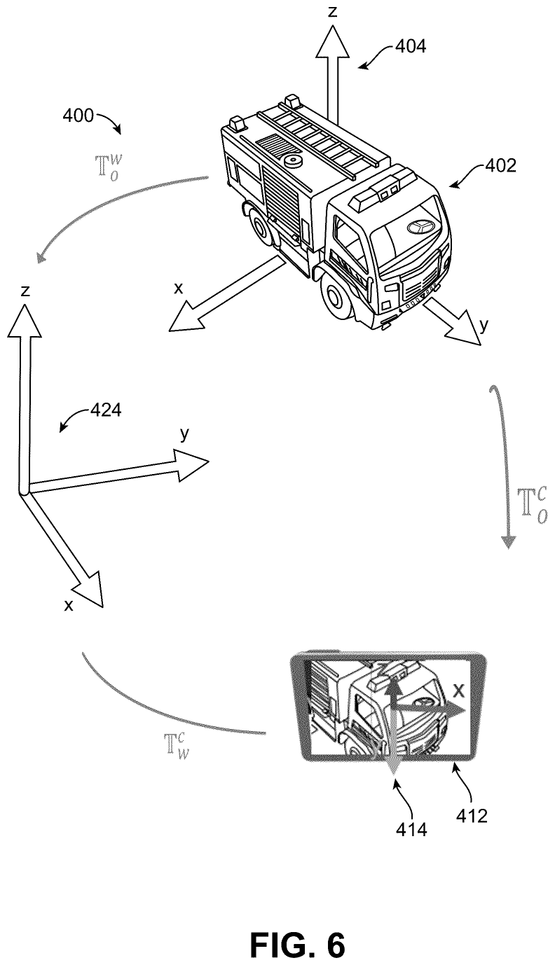

FIG. 6 illustrates system 400 in which object 402 may be tracked by XR device 412, according to various aspects of the present disclosure. FIG. 6 adds to system 400 by illustrating [symbol] , [symbol] , and [symbol] , [symbol] . To represents a transformation object coordinate system 404 and world coordinate system 424. [symbol] is a transformation matrix (e.g., a 4×4 matrix) used to change the frame of reference of 3D coordinates from object coordinate system 404 to world coordinate system 424.

[symbol] can be determined directly. However, determining [symbol] directly may be computationally expensive. [symbol] can be determined as a combination of [symbol] and [symbol] . Because [symbol] may be provided by a world tracker of XR device 412, it may be less computationally expensive to determine [symbol] as a combination of [symbol] and [symbol] than to determine [symbol] directly.

Further, in many cases, object 402 may be stationary, or mostly stationary. Mostly stationary may mean that object 402 may not move more than a threshold amount between frames captured by XR device 412. For example, XR device 412 may capture images at 30 frames per second. Object 402 may be mostly stationary if object 402 moves less than 1 centimeter in 1 second. In cases in which object 402 is mostly stationary, [symbol] may be relatively constant (e.g., relatively unchanging between frames).

Thus, XR device 412 may track object 402 by determining [symbol] (e.g., based on SLAM techniques and/or data from IMUs) and optimizing [symbol] over a number of images of object 402.

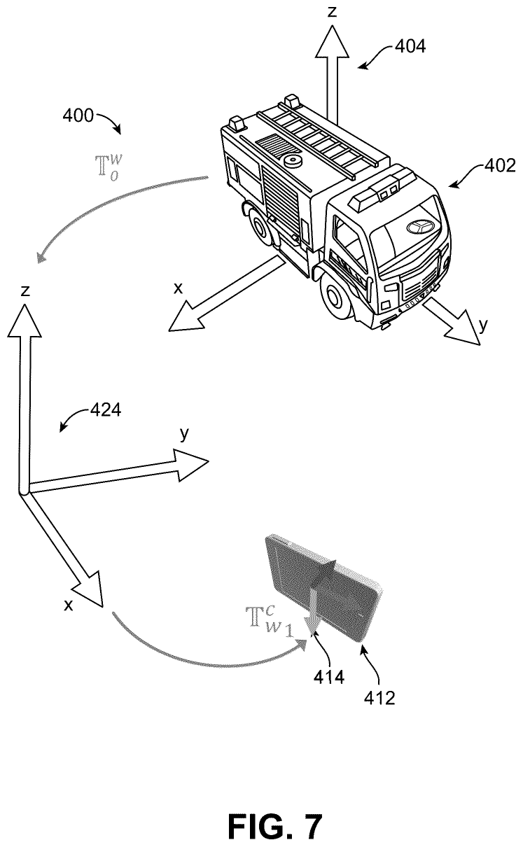

FIG. 7 illustrates system 400 in which object 402 may be tracked by XR device 412, according to various aspects of the present disclosure. FIG. 7 illustrates XR device 412 in a first position and a first world to camera transformation [symbol] .

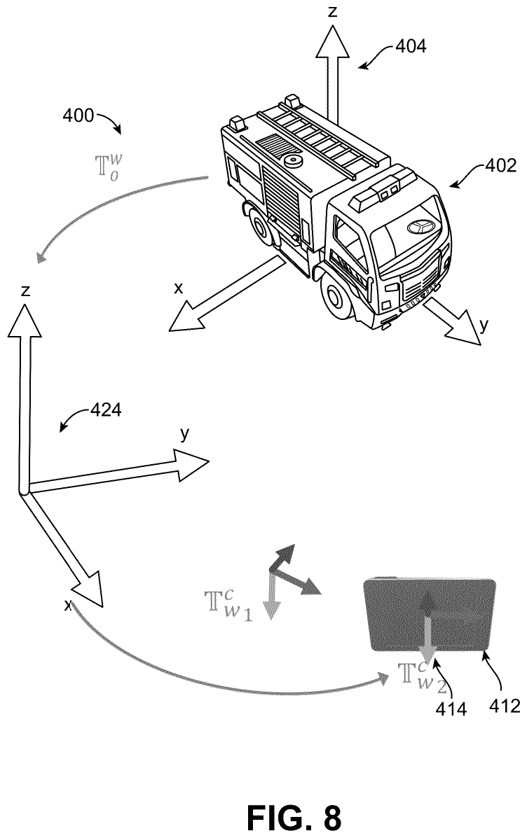

FIG. 8 illustrates system 400 in which object 402 may be tracked by XR device 412, according to various aspects of the present disclosure. FIG. 8 illustrates XR device 412 in a second position and a second world to camera transformation [symbol] .

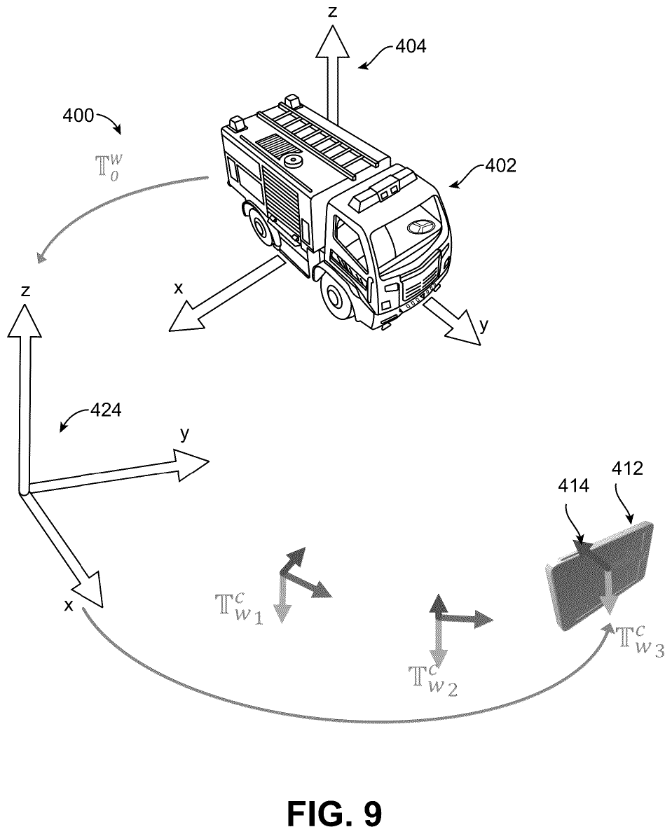

FIG. 9 illustrates system 400 in which object 402 may be tracked by XR device 412, according to various aspects of the present disclosure. FIG. 9 illustrates XR device 412 in a third position and a third world to camera transformation [symbol] .

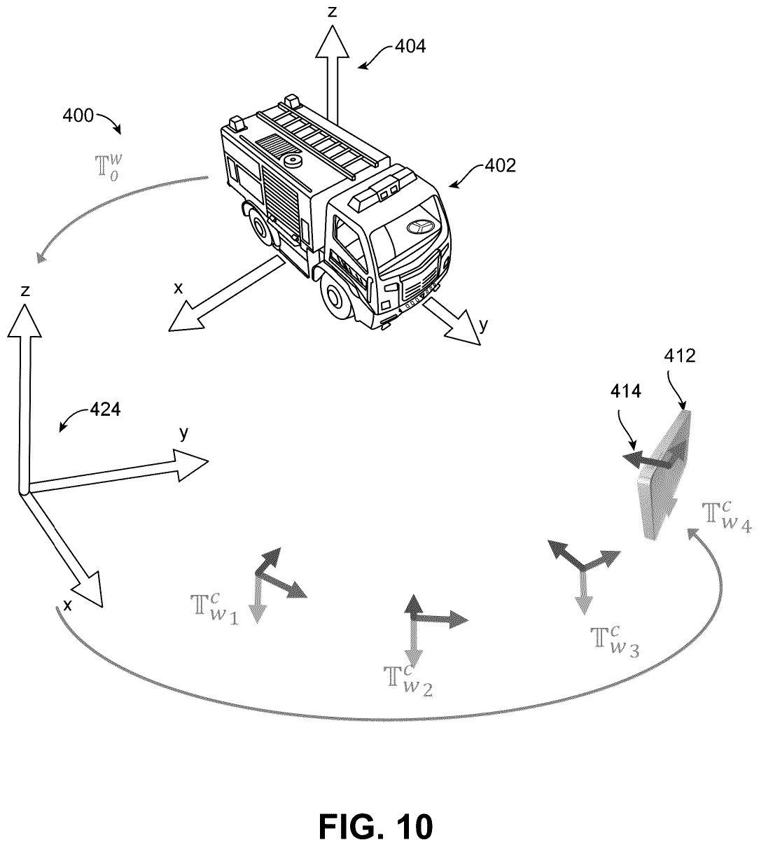

FIG. 10 illustrates system 400 in which object 402 may be tracked by XR device 412, according to various aspects of the present disclosure. FIG. 10 illustrates XR device 412 in a fourth position and a fourth world to camera transformation [symbol] . As can be seen when comparing FIG. 7 through FIG. 10, if object 402 is stationary, [symbol] remains constant.

XR device 412 may adjust the pose parameters of object 402 in a world coordinate system (ωₒ^{w}) to optimize the pose parameters. As an example of optimizing the pose parameters, XR device 412 may adjust the pose parameters of object 402 in a world coordinate system (ωₒ^{w}) in a way such that the sum of the (squared) reprojection error (difference between projected point (\hat{x}_{i,j}) and visual correspondence (x_{i,j})) over multiple views (indexed by j) is minimized. For example, XR device 412 may operate according to.

$${arg min}_{{ω}_{o}^{w}} {\sum }_{j} {\sum }_{i} {( {x}_{i , j} - {\hat{x}}_{i , j} )}^{2}$$

This can be done, because all views (e.g., as illustrated by FIG. 7 through FIG. 10) share the same transformation [symbol] when object 402 is not moving relative to the world. Additionally, or alternatively, an additional loss function (Huber, Cauchy, Tukey, etc.) may be added to the squared difference terms before summing them up. Additionally, or alternatively, there are other techniques for optimizing. Any of these other techniques and/or formulae may be used.

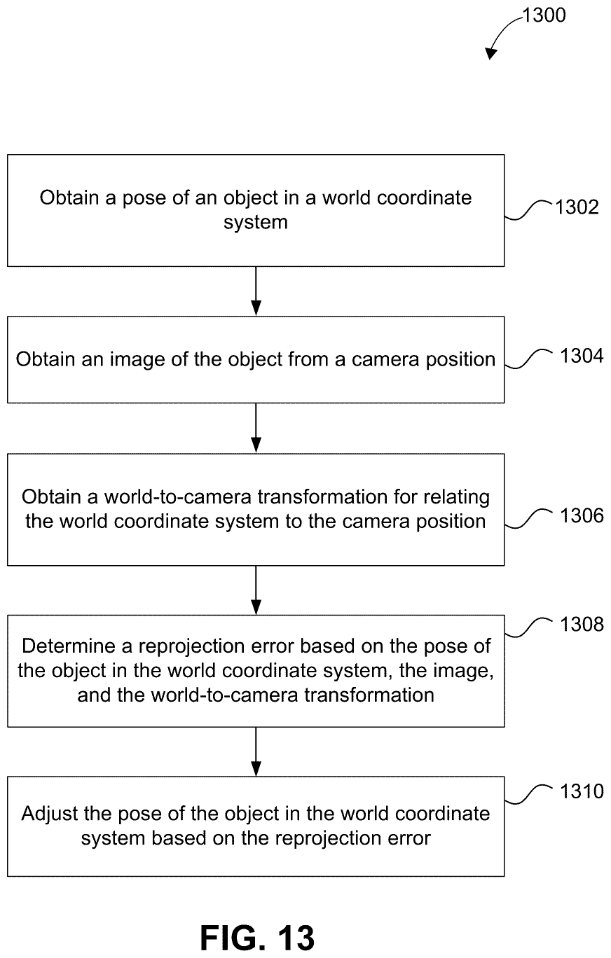

XR device 412 may obtain a pose of object 402 in the world coordinate system [symbol] . As an example of how XR device 412 may obtain the pose of object 402 in the world coordinate system [symbol] , XR device 412 may obtain a first image of object 402, the first image captured from a first camera position (e.g., an image captured from the first position of FIG. 13). XR device 412 may determine a pose of object 402 in a camera coordinate system [symbol] based on the first image of object 402 and the first camera position. The pose of object 402 in the camera coordinate system may be, or may include, a position of object 402 relative to the first camera position and an orientation of object 402.

Continuing the example, XR device 412 may obtain a first world-to-camera transformation [symbol] for relating a world coordinate system to the first camera position. The world-to-camera transformation [symbol] may be determined based on data from the IMUs and/or the SLAM technique. XR device 412 may determine a pose of object 402 in the world coordinate system [symbol] based on the pose of object 402 in the camera coordinate system [symbol] and the first world-to-camera transformation [symbol] . For example, XR device 412 may determine the pose of object 402 in the world coordinate system [symbol] by inverting the first world-to-camera transformation [symbol] and applying the inverted world-to-camera transformation [symbol] to the pose of object 402 in the camera coordinate system [symbol] to determine the pose of object 402 in the world coordinate system [symbol] .

Having obtained the pose of object 402 in the world coordinate system [symbol] (either based on a first image or not), XR device 412 may obtain an image of object 402 from a camera position and obtain a world-to-camera transformation [symbol] for relating the world coordinate system to the camera position. For example, XR device 412 may obtain an image of object 402 from the position of FIG. 8. The XR device 412 may optimize the pose of object 402 in the world coordinate system ( [symbol] ) based on the image and the world-to-camera transformation [symbol] .

For example, XR device 412 may reproject, based on the world-to-camera transformation [symbol] , a model of object 402 in the pose of object 402 in the world coordinate system [symbol] into an image plane based on the camera position. XR device 412 may identify features of object 402 based on the model of object 402. The features may be visually distinctive portions of object 402. XR device 412 may determine a reprojection error based on comparing locations of the features of object 402 in the image x_{i,j} with locations of the features of object 402 \hat{x}_{i,j} as represented by the model of object 402 in the pose of object 402 in the world coordinate system as reprojected into the image plane based on the camera position. XR device 412 may adjust the pose of object 402 in the world coordinate system [symbol] based on the reprojection error.

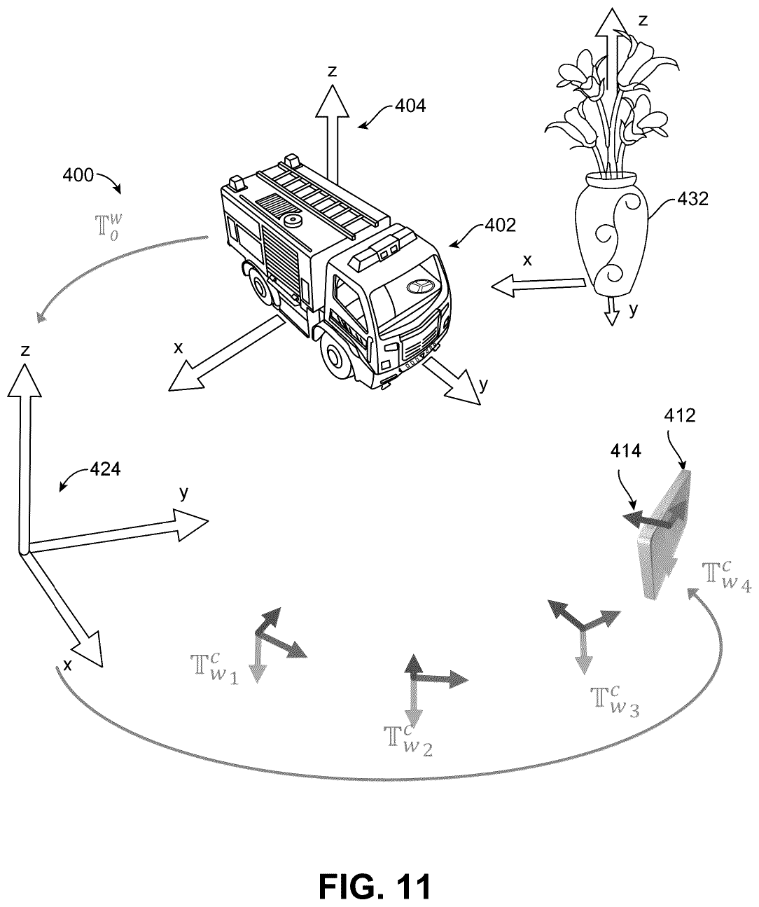

FIG. 11 is a diagram illustrating a scenario in which XR device 412 tracks two objects. For example, a scene may include object 402 and object 432. XR device 412 may capture both object 402 and object 432 in its field of view. Further, XR device 412 may track poses of both object 402 and object 432. To conserve computational resources, XR device 412 may adjust the pose of both object 402 and object 432 in the world coordinate system based on the same reprojection error. For example, XR device 412 may determine that object 402 and object 432 are both mostly stationary in the scene. Based on both object 402 and object 432 being mostly stationary, XR device 412 may determine that any changes to the pose of object 402 may apply to object 432 as well based on any changes to the pose of both object 402 and object 432 being the result of movement of XR device 412. Accordingly, having determined a reprojection error based on object 402, for example, as described above with regard to FIGS. 5-10, XR device 412 may adjust the pose of object 432 in the world coordinate system based on the same reprojection error.

In some aspects, XR device 412 may determine to group object 402 and object 432 (and/or any other mostly-stationary objects in the scene). Further, XR device 412 may determine to adjust (e.g., update) the poses of all of the objects of the group together based on a determined reprojection error. For example, XR device 412 may determine a reprojection error based on one object of the group and apply the same reprojection error to update the poses of all the objects of the group. In some aspects, XR device 412 may update membership in the group based on the members of the group being mostly stationary. For example, XR device 412 may remove from the group objects that move and/or add to the group additional objects that are determined to be mostly stationary.

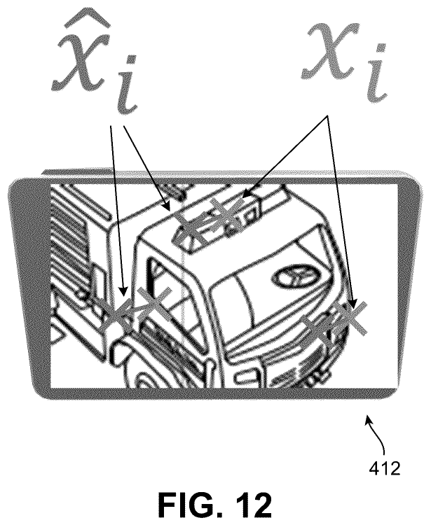

FIG. 12 illustrates locations of example features \hat{x}_{i,j} in a first image and corresponding locations of corresponding features x_{i,j} from projecting the known 3D points of a reference (for instance a known point cloud model of the firetruck) onto the camera frame via a given pose. The locations of example features \hat{x}_{i,j} and the corresponding locations of corresponding features x_{i,j} may be used to calculate a reprojection error, according to various aspects of the present disclosure. The first image may be a captured image. The reference may be a model of the object in the pose of the object in the world coordinate system as reprojected into the image plane based on the camera position (e.g., the position from which the first image was captured.

FIG. 13 is a flow diagram illustrating a process 1300 for optimizing a pose of an object, in accordance with aspects of the present disclosure. One or more operations of process 1300 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The one or more operations of process 1300 may be implemented as software components that are executed and run on one or more processors.

At block 1302, a computing device (or one or more components thereof) may obtain a pose of an object in a world coordinate system [[ [symbol] ]]. For example, XR device 412 of FIG. 4 through FIG. 12 may obtain a pose of object 402 of FIG. 4 through FIG. 10 in object coordinate system 404 of FIG. 4 through FIG. 10.

In some aspects, to obtain the pose of an object in a world coordinate system [[ [symbol] ]], the computing device (or one or more components thereof) may determine a pose of the object in a camera coordinate system [[ [symbol] ]] based on a second image of the object captured from a second camera position, wherein the pose of the object in the camera coordinate system comprises a position of the object relative to the second camera position and an orientation of the object; and invert the a second world-to-camera transformation [[ [symbol] ]] and applying the inverted second world-to-camera transformation [[ [symbol] ]] to the pose of the object in the camera coordinate system [[ [symbol] ]] to determine the pose of the object in the world coordinate system [[ [symbol] ]].

In some aspects, to obtain the pose of an object in a world coordinate system [[ [symbol] ]], the computing device (or one or more components thereof) may determine the pose of the object in a world coordinate system [[ [symbol] ]] based on one or more of: a plurality of images from a respective plurality of cameras; a predetermined alignment; automatic alignment based on QR code recognition; or a deep-learning pose-recognition technique.

At block 1304, the computing device (or one or more components thereof) may obtain an image of the object from a camera position. For example, XR device 412 may obtain an image of object 402 (e.g., from any of the positions of FIG. 6 through FIG. 10).

In some aspects, the computing device (or one or more components thereof) may determine to use the image from among a plurality of images. For example, the computing device (or one or more components thereof) may capture a plurality of images and determine to use the image used at block 1304 from among the plurality of images. In some aspects, the image used at block 1304 may be selected based on one or more of: a difference between the camera position and another camera position; a difference between a camera orientation and another camera orientation; a difference between a timestamp of the image and a timestamp of another image; or a quality of the image. For example, the computing device (or one or more components thereof) may capture multiple camera images from multiple camera locations and/or at multiple camera orientations. The computing device (or one or more components thereof) may determine to use the image used at block 1304 based on changes in position and/or orientation compared with other camera positions and/or orientations corresponding to other images previously used to determine or adjust the pose of the object in the world coordinate system. Additionally, or alternatively, the computing device (or one or more components thereof) may determine to use the image based on time having passed since a prior image was used to adjust the pose of the object in the world coordinate system.

At block 1306, the computing device (or one or more components thereof) may obtain a world-to-camera transformation [[ [symbol] ]] for relating the world coordinate system to the camera position. For example, XR device 412 may obtain a world-to-camera transformation [[ [symbol] ]] (e.g., from any of the world-to-camera transformation [[ [symbol] ]] of FIG. 6 through FIG. 10).

In some aspects, the world-to-camera transformation may be based on one or more of: inertial data obtained from one or more inertial measurement units (IMUs); or relative position data based on a simultaneous localization and mapping (SLAM) technique.

At block 1308, the computing device (or one or more components thereof) may determine a reprojection error based on the pose of the object in the world coordinate system [[ [symbol] ]], the image, and the world-to-camera transformation [[ [symbol] ]]. For example, XR device 412 may determine a reprojection error based on the pose of object 402 (e.g., as obtained at block 1302), the image obtained at block 1304, and the world-to-camera transformation [[ [symbol] ]] obtained at block 1306.

In some aspects, to determine the reprojection error, the computing device (or one or more components thereof) may obtain a model of the object; obtain features of the object based the model of the object; and determine the reprojection error based on comparing locations of the features of the object in the image with locations of the features of the object as reprojected from the model of the object in the pose of the object in the world coordinate system into an image plane based on the camera position. In some aspects, the model of the object may be, or may include, a point-cloud model of the object, a computer-aided design model of the object, or a neural radiance field.

In some aspects, to determine the reprojection error, the computing device (or one or more components thereof) may obtain a model of the object; obtain features of the object based the model of the object; determine the reprojection error based on comparing locations of the features of the object in the image [[x_{i,j}]] with locations of the features of the object [[x_{i,j}]] as represented by the model of the object with the pose of the object in the world coordinate system [ [symbol] ] and world-to-camera transformation [[ [symbol] ]] applied to the model of the object.

In some aspects, the computing device (or one or more components thereof) may track the object. For example, the computing device (or one or more components thereof) may track the object based on the pose of the object in the world coordinate system [[ [symbol] ]] as adjusted by process 1300.

In some aspects, the computing device (or one or more components thereof) may generate virtual content based on the pose of the object in the world coordinate system [[ [symbol] ]].

In some aspects, to determine the reprojection error, the computing device (or one or more components thereof) may determine visual correspondences between the image and a representation of the object in the world coordinate system [[ [symbol] ]] with the world-to-camera transformation [[ [symbol] ]] applied thereunto. In some aspects, the visual correspondences may be determined based on one or more of: a template-matching technique; a feature-matching technique; or a deep-learning technique.

At block 1310, the computing device (or one or more components thereof) may adjust the pose of the object in the world coordinate system [[ [symbol] ]] based on the reprojection error. For example, XR device 412 may adjust the pose obtained at block 1302 based on the reprojection error determined at block 1308.

In some aspects, the computing device (or one or more components thereof) may determine that the object is mostly stationary. In such aspects, adjusting the pose of the object in the world coordinate system is based, at least in part, on determining that the object is mostly stationary. For example, process 1300 may be used for tracking of mostly stationary objects. In some aspects, the object may be determined to be mostly stationary based on one or more of: respective locations of the object in a plurality of images of the object; a categorization of the object; or data from one or more other sensors.

In some aspects, the computing device (or one or more components thereof) may obtain a second image of the object from a second camera position; obtain a second world-to-camera transformation for relating the world coordinate system to the second camera position; determine a second reprojection error based on the pose of the object in the world coordinate system, the second image, and the second world-to-camera transformation; and adjust the pose of the object in the world coordinate system based on the second reprojection error.

In some aspects, the computing device (or one or more components thereof) may obtain one or more images of the object from a one or more respective camera positions; obtain one or more respective world-to-camera transformations for relating the world coordinate system to the one or more respective camera positions; determine one or more respective reprojection errors based on the pose of the object in the world coordinate system, the one or more respective images, and the one or more respective world-to-camera transformations; and adjust the pose of the object in the world coordinate system based on the one or more respective reprojection errors. For example, as the camera changes position, additional images may be captured and the pose of the object in the world coordinate system may be updated based on each additional image.

In some aspects, the object may be a first object. Further, the computing device (or one or more components thereof) may determine that the first object is stationary; obtain a pose of a second object in the world coordinate system; determine that the second object is stationary; and adjust the pose of the second object in the world coordinate system based on the reprojection error. For example, XR device 412 may obtain a pose of an object 402 (e.g., the first object) and a pose of object 432 (e.g., the second object). XR device 412 may determine that object 402 is stationary (or mostly stationary). Also, XR device 412 may determine that XR device 432 is stationary (or mostly stationary). XR device 412 may adjust a pose of object 432 in the world coordinate system based on the reprojection error (e.g., the reprojection error determined at block 1308 based on the first object).

In some aspects, the computing device (or one or more components thereof) may obtain a second image of the first object from a second camera position; obtain a second world-to-camera transformation for relating the world coordinate system to the second camera position; determine a second reprojection error based on the pose of the first object in the world coordinate system, the second image, and the second world-to-camera transformation; adjust the pose of the first object in the world coordinate system based on the second reprojection error; and adjust the pose of the second object in the world coordinate system based on the second reprojection error.

For example, XR device 412 may obtain an image of object 402 from a second camera position (e.g., the position of illustrated and described with regard to FIG. 8 as compared with the position illustrated and described with regard to FIG. 7). XR device 412 may obtain a second world-to-camera transformation [symbol] . [symbol] may relate the world coordinate system 424 to the second camera position. XR device 412 may determine a second reprojection error based on the pose of object 402 in the world coordinate system 424, the second image, and the second world-to-camera transformation [symbol] . Further, XR device 412 may adjust the pose of object 402 in the world coordinate system 424 based on the second reprojection error. Additionally, XR device 412 may adjust the pose of object 432 in the world coordinate system 424 based on the second reprojection error.

In some aspects, the computing device (or one or more components thereof) may associate the first object with the second object based on the first object and the second object being stationary; determine further reprojection errors based on further poses of the first object in the world coordinate system, further images, and further work-to-camera transformations; adjust the pose of the first object in the world coordinate system and the pose of the second object in the world coordinate system based on the further reprojection errors based on the association between the first object and the second object. For example, XR device 412 may associate object 402 with object 432 based on object 402 and object 432 being stationary (or mostly stationary). XR device 412 may determine further reprojection errors based on further poses of the first object in the world coordinate system 424, further images (e.g., captured from further camera poses such as the camera poses illustrated and described with regard to FIGS. 7-10), and further work-to-camera transformations (e.g., [symbol] , [symbol] , and [symbol] as illustrated and described with regard to FIGS. 7-10). Further, XR device 412 may adjust the pose of object 402 in the world coordinate system 424 and the pose of object 432 in the world coordinate system 424 based on the further reprojection errors based on the association between the first object and the second object.

In some aspects, the computing device (or one or more components thereof) may determine that the second object is not stationary; disassociate the first object and the second object; and adjust the pose of the first object in the world coordinate system based on the further reprojection errors. For example, XR device 412, after having associated object 402 and object 432 based on determining that object 402 and object 432 are stationary, may determine that object 432 is not stationary. Having determined that object 432 is not stationary, XR device 432 may disassociate object 402 and object 432. Thereafter, XR device 412 may determine further reprojection errors based on object 402 and adjust the pose of object 402 based on the further reprojection errors. However, based on object 432 not being associated with object 402, XR device 412 may not adjust the pose of object 432 based on the further reprojection errors based on object 402.

In some examples, the methods described herein (e.g., process 1300, and/or other methods described herein) can be performed, in whole or in part, by a computing device or apparatus. In one example, one or more of the methods can be performed by XR system 100 of FIG. 1, XR device 102 of FIG. 1, companion device 104 of FIG. 1, XR system 200 of FIG. 2, XR system 300 of FIG. 3, or another system or device. In another example, one or more of the methods can be performed, in whole or in part, by the computing-device architecture 1400 shown in FIG. 14. For instance, a computing device with the computing-device architecture 1400 shown in FIG. 14 can include, or be included in, the components of the XR system 100 of FIG. 1, XR device 102 of FIG. 1, companion device 104 of FIG. 1, XR system 200 of FIG. 2, XR system 300 of FIG. 3, or another system or device and can implement the operations of the process 1300, and/or other process described herein.

The computing device can include any suitable device, such as a vehicle or a computing device of a vehicle, a mobile device (e.g., a mobile phone), a desktop computing device, a tablet computing device, a wearable device (e.g., a VR headset, an AR headset, AR glasses, a network-connected watch or smartwatch, or other wearable device), a server computer, a robotic device, a television, and/or any other computing device with the resource capabilities to perform the processes described herein, including process 1300, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 1300, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 1300, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

FIG. 14 illustrates an example computing-device architecture 1400 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1400 may include, implement, or be included in, any or all of XR system 100 of FIG. 1, XR device 102 of FIG. 1, companion device 104 of FIG. 1, XR system 300 of FIG. 2, XR system 300 of FIG. 3, companion device 322 of FIG. 3, or another system or device.

The components of computing-device architecture 1400 are shown in electrical communication with each other using connection 1412, such as a bus. The example computing-device architecture 1400 includes a processing unit (CPU or processor) 1402 and computing device connection 1412 that couples various computing device components including computing device memory 1410, such as read only memory (ROM) 1408 and random-access memory (RAM) 1406, to processor 1402.

Computing-device architecture 1400 can include a cache of high-speed memory connected directly with, in close proximity to, or integrated as part of processor 1402. Computing-device architecture 1400 can copy data from memory 1410 and/or the storage device 1414 to cache 1404 for quick access by processor 1402. In this way, the cache can provide a performance boost that avoids processor 1402 delays while waiting for data. These and other engines can control or be configured to control processor 1402 to perform various actions. Other computing device memory 1410 may be available for use as well. Memory 1410 can include multiple different types of memory with different performance characteristics. Processor 1402 can include any general-purpose processor and a hardware or software service, such as service 1 1416, service 2 1418, and service 3 1420 stored in storage device 1414, configured to control processor 1402 as well as a special-purpose processor where software instructions are incorporated into the processor design. Processor 1402 may be a self-contained system, containing multiple cores or processors, a bus, memory controller, cache, etc. A multi-core processor may be symmetric or asymmetric.

To enable user interaction with the computing-device architecture 1400, input device 1422 can represent any number of input mechanisms, such as a microphone for speech, a touch-sensitive screen for gesture or graphical input, keyboard, mouse, motion input, speech and so forth. Output device 1424 can also be one or more of a number of output mechanisms known to those of skill in the art, such as a display, projector, television, speaker device, etc. In some instances, multimodal computing devices can enable a user to provide multiple types of input to communicate with computing-device architecture 1400. Communication interface 1426 can generally govern and manage the user input and computing device output. There is no restriction on operating on any particular hardware arrangement and therefore the basic features here may easily be substituted for improved hardware or firmware arrangements as they are developed.

Storage device 1414 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 1406, read only memory (ROM) 1408, and hybrids thereof. Storage device 1414 can include services 1416, 1418, and 1420 for controlling processor 1402. Other hardware or software engines or modules are contemplated. Storage device 1414 can be connected to the computing device connection 1412. In one aspect, a hardware engine or module that performs a particular function can include the software component stored in a computer-readable medium in connection with the necessary hardware components, such as processor 1402, connection 1412, output device 1424, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for tracking objects, the apparatus comprising: at least one memory; and at least one processor coupled to the at least one memory and configured to: obtain a pose of an object in a world coordinate system; obtain an image of the object from a camera position; obtain a world-to-camera transformation for relating the world coordinate system to the camera position; determine a reprojection error based on the pose of the object in the world coordinate system, the image, and the world-to-camera transformation; and adjust the pose of the object in the world coordinate system based on the reprojection error.

Aspect 2. The apparatus of aspect 1, wherein the at least one processor is further configured to determine that the object is mostly stationary, wherein adjusting the pose of the object in the world coordinate system is based, at least in part, on determining that the object is mostly stationary.

Aspect 3. The apparatus of any one of aspects 1 or 2, wherein the object is determined to be mostly stationary based on one or more of: respective locations of the object in a plurality of images of the object; a categorization of the object; or data from one or more other sensors.

Aspect 4. The apparatus of any one of aspects 1 to 3, wherein: the image comprises a first image; the camera position comprises a first camera position; the world-to-camera transformation comprises a first world-to-camera transformation; the reprojection error comprises a first reprojection error; and wherein the at least one processor is further configured to: obtain a second image of the object from a second camera position; obtain a second world-to-camera transformation for relating the world coordinate system to the second camera position; determine a second reprojection error based on the pose of the object in the world coordinate system, the second image, and the second world-to-camera transformation; and adjust the pose of the object in the world coordinate system based on the second reprojection error.

Aspect 5. The apparatus of any one of aspects 1 to 4, wherein to determine the reprojection error, the at least one processor is further configured to: obtain a model of the object; obtain features of the object based the model of the object; and determine the reprojection error based on comparing locations of the features of the object in the image with locations of the features of the object as reprojected from the model of the object in the pose of the object in the world coordinate system into an image plane based on the camera position.

Aspect 6. The apparatus of aspect 5, wherein the model of the object comprises a point-cloud model of the object, a computer-aided design model of the object, or a neural radiance field.

Aspect 7. The apparatus of any one of aspects 1 to 6, wherein to determine the reprojection error, the at least one processor is further configured to: obtain a model of the object; obtain features of the object based the model of the object; and determine the reprojection error based on comparing locations of the features of the object in the image with locations of the features of the object as represented by the model of the object with the pose of the object in the world coordinate system and world-to-camera transformation applied to the model of the object.

Aspect 8. The apparatus of any one of aspects 1 to 7, wherein to determine the reprojection error, the at least one processor is further configured to determine visual correspondences between the image and a representation of the object in the world coordinate system with the world-to-camera transformation applied thereunto.

Aspect 9. The apparatus of aspect 8, wherein the visual correspondences are determined based on one or more of: a template-matching technique; a feature-matching technique; or a deep-learning technique.

Aspect 10. The apparatus of any one of aspects 1 to 9, wherein to obtaining the pose of the object in the world coordinate system, the at least one processor is further configured to: determine a pose of the object in a camera coordinate system based on a second image of the object captured from a second camera position, wherein the pose of the object in the camera coordinate system comprises a position of the object relative to the second camera position and an orientation of the object; and invert a second world-to-camera transformation and apply the inverted second world-to-camera transformation to the pose of the object in the camera coordinate system to determine the pose of the object in the world coordinate system.

Aspect 11. The apparatus of any one of aspects 1 to 10, wherein the at least one processor is further configured to determine the pose of the object in the world coordinate system based on one or more of: a plurality of images from a respective plurality of cameras; a predetermined alignment; automatic alignment based on QR code recognition; or a deep-learning pose-recognition technique.

Aspect 12. The apparatus of any one of aspects 1 to 11, wherein the world-to-camera transformation is based on one or more of: inertial data obtained from one or more inertial measurement units (IMUs); or relative position data based on a simultaneous localization and mapping (SLAM) technique.

Aspect 13. The apparatus of any one of aspects 1 to 13, wherein the at least one processor is further configured to determine to use the image from among a plurality of images.

Aspect 14. The apparatus of aspect 13, wherein the image is determined to be used based on one or more of: a difference between the camera position and another camera position; a difference between a camera orientation and another camera orientation; a difference between a timestamp of the image and a timestamp of another image; or a quality of the image.

Aspect 15. The apparatus of any one of aspects 1 to 14, wherein the at least one processor is further configured to track the object.

Aspect 16. The apparatus of any one of aspects 1 to 15, wherein the at least one processor is further configured to generate virtual content based on the pose of the object in the world coordinate system.

Aspect 17. A method for tracking objects, the method comprising: obtaining a pose of an object in a world coordinate system; obtaining an image of the object from a camera position; obtaining a world-to-camera transformation for relating the world coordinate system to the camera position; determining a reprojection error based on the pose of the object in the world coordinate system, the image, and the world-to-camera transformation; and adjusting the pose of the object in the world coordinate system based on the reprojection error.

Aspect 18. The method of aspect 17, further comprising determining that the object is mostly stationary, wherein adjusting the pose of the object in the world coordinate system is based, at least in part, on determining that the object is mostly stationary.

Aspect 19. The method of any one of aspects 17 or 18, wherein the object is determined to be mostly stationary based on one or more of: respective locations of the object in a plurality of images of the object; a categorization of the object; or data from one or more other sensors.

Aspect 20. The method of any one of aspects 17 to 19, wherein: the image comprises a first image; the camera position comprises a first camera position; the world-to-camera transformation comprises a first world-to-camera transformation; the reprojection error comprises a first reprojection error; and the method further comprises: obtaining a second image of the object from a second camera position; obtaining a second world-to-camera transformation for relating the world coordinate system to the second camera position; determining a second reprojection error based on the pose of the object in the world coordinate system, the second image, and the second world-to-camera transformation; and adjusting the pose of the object in the world coordinate system based on the second reprojection error.

Aspect 21. The method of any one of aspects 17 to 20, wherein determining the reprojection error comprises: obtaining a model of the object; obtaining features of the object based the model of the object; and determining the reprojection error based on comparing locations of the features of the object in the image with locations of the features of the object as reprojected from the model of the object in the pose of the object in the world coordinate system into an image plane based on the camera position.

Aspect 22. The method of aspect 21, wherein the model of the object comprises a point-cloud model of the object, a computer-aided design model of the object, or a neural radiance field.

Aspect 23. The method of any one of aspects 17 to 22, wherein determining the reprojection error comprises: obtaining a model of the object; obtaining features of the object based the model of the object; and determining the reprojection error based on comparing locations of the features of the object in the image with locations of the features of the object as represented by the model of the object with the pose of the object in the world coordinate system and world-to-camera transformation applied to the model of the object.

Aspect 24. The method of any one of aspects 17 to 23, wherein determining the reprojection error comprises determining visual correspondences between the image and a representation of the object in the world coordinate system with the world-to-camera transformation applied thereunto.

Aspect 25. The method of aspect 24, wherein the visual correspondences are determined based on one or more of: a template-matching technique; a feature-matching technique; or a deep-learning technique.

Aspect 26. The method of any one of aspects 17 to 25, wherein obtaining the pose of the object in the world coordinate system comprises: determining a pose of the object in a camera coordinate system based on a second image of the object captured from a second camera position, wherein the pose of the object in the camera coordinate system comprises a position of the object relative to the second camera position and an orientation of the object; and inverting a second world-to-camera transformation and applying the inverted second world-to-camera transformation to the pose of the object in the camera coordinate system to determine the pose of the object in the world coordinate system.

Aspect 27. The method of any one of aspects 17 to 26, further comprising determining the pose of the object in the world coordinate system based on one or more of: a plurality of images from a respective plurality of cameras; a predetermined alignment; automatic alignment based on QR code recognition; or a deep-learning pose-recognition technique.

Aspect 28. The method of any one of aspects 17 to 27, wherein the world-to-camera transformation is based on one or more of: inertial data obtained from one or more inertial measurement units (IMUs); or relative position data based on a simultaneous localization and mapping (SLAM) technique.

Aspect 29. The method of any one of aspects 17 to 28, further comprising determining to use the image from among a plurality of images.

Aspect 30. The method of aspect 29, wherein the image is determined to be used based on one or more of: a difference between the camera position and another camera position; a difference between a camera orientation and another camera orientation; a difference between a timestamp of the image and a timestamp of another image; or a quality of the image.

Aspect 31. The method of any one of aspects 17 to 30, further comprising tracking the object.

Aspect 32. The method of any one of aspects 17 to 31, further comprising generating virtual content based on the pose of the object in the world coordinate system.

Aspect 33. The apparatus of any one of aspects 1 to 16, wherein the at least one processor is further configured to determine that the object is stationary, wherein adjusting the pose of the object in the world coordinate system is based, at least in part, on determining that the object is stationary.

Aspect 34. The apparatus of any one of aspects 1 to 16 or 33, wherein the object is determined to be stationary based on one or more of: respective locations of the object in a plurality of images of the object; a categorization of the object; or data from one or more other sensors.

Aspect 35. The apparatus of any one of aspects 1 to 16, 33 or 34, wherein the object comprises a first object and wherein the at least one processor is further configured to: determine that the first object is stationary; obtain a pose of a second object in the world coordinate system;
determine that the second object is stationary; and adjust the pose of the second object in the world coordinate system based on the reprojection error.

Aspect 36. The apparatus of any one of aspects 1 to 16, or 33 to 35, wherein the at least one processor is further configured to: obtain a second image of the first object from a second camera position; obtain a second world-to-camera transformation for relating the world coordinate system to the second camera position; determine a second reprojection error based on the pose of the first object in the world coordinate system, the second image, and the second world-to-camera transformation; adjust the pose of the first object in the world coordinate system based on the second reprojection error; and adjust the pose of the second object in the world coordinate system based on the second reprojection error.

Aspect 37. The apparatus of any one of aspects 1 to 16, or 33 to 36, wherein the at least one processor is further configured to: associate the first object with the second object based on the first object and the second object being stationary; determine further reprojection errors based on further poses of the first object in the world coordinate system, further images, and further work-to-camera transformations; adjust the pose of the first object in the world coordinate system and the pose of the second object in the world coordinate system based on the further reprojection errors based on the association between the first object and the second object.

Aspect 38. The apparatus of any one of aspects 1 to 16, or 33 to 37, wherein the at least one processor is further configured to: determine that the second object is not stationary; disassociate the first object and the second object; and adjust the pose of the first object in the world coordinate system based on the further reprojection errors.

Aspect 39. The method of any one of aspects 17 to 32, further comprising determining that the object is stationary, wherein adjusting the pose of the object in the world coordinate system is based, at least in part, on determining that the object is stationary.

Aspect 40. The method of any one of aspects 17 to 32 or 39, wherein the object is determined to be stationary based on one or more of: respective locations of the object in a plurality of images of the object; a categorization of the object; or data from one or more other sensors.

Aspect 41. The method of any one of aspects 17 to 32, 39, or 40, further comprising determining that the object is stationary, wherein adjusting the pose of the object in the world coordinate system is based, at least in part, on determining that the object is stationary.

Aspect 42. The method of any one of aspects 17 to 32 or 39 to 41, wherein the object is determined to be stationary based on one or more of: respective locations of the object in a plurality of images of the object; a categorization of the object; or data from one or more other sensors.

Aspect 43. The method of any one of aspects 17 to 32 or 39 to 42, wherein: the image comprises a first image; the camera position comprises a first camera position; the world-to-camera transformation comprises a first world-to-camera transformation; the reprojection error comprises a first reprojection error; and the method further comprises: obtaining a second image of the object from a second camera position; obtaining a second world-to-camera transformation for relating the world coordinate system to the second camera position; determining a second reprojection error based on the pose of the object in the world coordinate system, the second image, and the second world-to-camera transformation; and adjusting the pose of the object in the world coordinate system based on the second reprojection error.

Aspect 44. The method of any one of aspects 17 to 32 or 39 to 43, further comprising:
determining that the first object is stationary; obtaining a pose of a second object in the world coordinate system; determining that the second object is stationary; and adjusting the pose of the second object in the world coordinate system based on the reprojection error.

Aspect 45. The method of any one of aspects 17 to 32 or 39 to 44, further comprising: obtain a second image of the first object from a second camera position; obtain a second world-to-camera transformation for relating the world coordinate system to the second camera position; determine a second reprojection error based on the pose of the first object in the world coordinate system, the second image, and the second world-to-camera transformation; adjust the pose of the first object in the world coordinate system based on the second reprojection error; and adjust the pose of the second object in the world coordinate system based on the second reprojection error.

Aspect 46. The method of any one of aspects 17 to 32 or 39 to 45, further comprising: associating the first object with the second object based on the first object and the second object being stationary; determining further reprojection errors based on further poses of the first object in the world coordinate system, further images, and further work-to-camera transformations; adjusting the pose of the first object in the world coordinate system and the pose of the second object in the world coordinate system based on the further reprojection errors based on the association between the first object and the second object.

Aspect 47. The method of any one of aspects 17 to 32 or 39 to 46, further comprising: determining that the second object is not stationary; disassociating the first object and the second object; and adjusting the pose of the first object in the world coordinate system based on the further reprojection errors.

Aspect 48. A non-transitory computer-readable storage medium having stored thereon instructions that, when executed by at least one processor, cause the at least one processor to perform operations according to any of aspects 17 to 32 or 39 to 47.

Aspect 49. An apparatus for providing virtual content for display, the apparatus comprising one or more means for perform operations according to any of aspects 17 to 32 or 39 to 47.

What is claimed is:

1. An apparatus for tracking objects, the apparatus comprising:
at least one memory; and
at least one processor coupled to the at least one memory and configured to:
obtain a pose of an object in a world coordinate system;
obtain an image of the object from a camera position;
obtain a world-to-camera transformation for relating the world coordinate system to the camera position;
determine a reprojection error based on the pose of the object in the world coordinate system, the image, and the world-to-camera transformation; and
adjust the pose of the object in the world coordinate system based on the reprojection error.

2. The apparatus of claim 1, wherein the at least one processor is further configured to determine that the object is stationary, wherein adjusting the pose of the object in the world coordinate system is based, at least in part, on determining that the object is stationary.

3. The apparatus of claim 2, wherein the object is determined to be stationary based on one or more of:
respective locations of the object in a plurality of images of the object;
a categorization of the object; or
data from one or more other sensors.

4. The apparatus of claim 1, wherein:
the image comprises a first image;
the camera position comprises a first camera position;
the world-to-camera transformation comprises a first world-to-camera transformation;
the reprojection error comprises a first reprojection error; and
the at least one processor is further configured to:
obtain a second image of the object from a second camera position;
obtain a second world-to-camera transformation for relating the world coordinate system to the second camera position;
determine a second reprojection error based on the pose of the object in the world coordinate system, the second image, and the second world-to-camera transformation; and
adjust the pose of the object in the world coordinate system based on the second reprojection error.

5. The apparatus of claim 1, wherein to determine the reprojection error, the at least one processor is further configured to:
obtain a model of the object;
obtain features of the object based the model of the object; and
determine the reprojection error based on comparing locations of the features of the object in the image with locations of the features of the object as reprojected from the model of the object in the pose of the object in the world coordinate system into an image plane based on the camera position.

6. The apparatus of claim 5, wherein the model of the object comprises a point-cloud model of the object, a computer-aided design model of the object, or a neural radiance field.

7. The apparatus of claim 1, wherein to determine the reprojection error, the at least one processor is further configured to:
obtain a model of the object;
obtain features of the object based the model of the object; and
determine the reprojection error based on comparing locations of the features of the object in the image with locations of the features of the object as represented by the model of the object with the pose of the object in the world coordinate system and world-to-camera transformation applied to the model of the object.

8. The apparatus of claim 1, wherein to determine the reprojection error, the at least one processor is further configured to determine visual correspondences between the image and a representation of the object in the world coordinate system with the world-to-camera transformation applied thereunto.

9. The apparatus of claim 8, wherein the visual correspondences are determined based on one or more of:
a template-matching technique;
a feature-matching technique; or
a deep-learning technique.

10. The apparatus of claim 1, wherein to obtaining the pose of the object in the world coordinate system, the at least one processor is further configured to:
determine a pose of the object in a camera coordinate system based on a second image of the object captured from a second camera position, wherein the pose of the object in the camera coordinate system comprises a position of the object relative to the second camera position and an orientation of the object; and
invert a second world-to-camera transformation and apply the inverted second world-to-camera transformation to the pose of the object in the camera coordinate system to determine the pose of the object in the world coordinate system.

11. The apparatus of claim 1, wherein the at least one processor is further configured to determine the pose of the object in the world coordinate system based on one or more of:
a plurality of images from a respective plurality of cameras;
a predetermined alignment;
automatic alignment based on QR code recognition; or
a deep-learning pose-recognition technique.

12. The apparatus of claim 1, wherein the world-to-camera transformation is based on one or more of:
inertial data obtained from one or more inertial measurement units (IMUs); or
relative position data based on a simultaneous localization and mapping (SLAM) technique.

13. The apparatus of claim 1, wherein the at least one processor is further configured to determine to use the image from among a plurality of images.

14. The apparatus of claim 13, wherein the image is determined to be used based on one or more of:
a difference between the camera position and another camera position;
a difference between a camera orientation and another camera orientation;
a difference between a timestamp of the image and a timestamp of another image; or
a quality of the image.

15. The apparatus of claim 1, wherein the object comprises a first object and wherein the at least one processor is further configured to:
determine that the first object is stationary;
obtain a pose of a second object in the world coordinate system;
determine that the second object is stationary; and
adjust the pose of the second object in the world coordinate system based on the reprojection error.

16. The apparatus of claim 15, wherein the at least one processor is further configured to:
obtain a second image of the first object from a second camera position;
obtain a second world-to-camera transformation for relating the world coordinate system to the second camera position;
determine a second reprojection error based on the pose of the first object in the world coordinate system, the second image, and the second world-to-camera transformation;
adjust the pose of the first object in the world coordinate system based on the second reprojection error; and
adjust the pose of the second object in the world coordinate system based on the second reprojection error.

17. The apparatus of claim 15, wherein the at least one processor is further configured to:
associate the first object with the second object based on the first object and the second object being stationary;
determine further reprojection errors based on further poses of the first object in the world coordinate system, further images, and further work-to-camera transformations;
adjust the pose of the first object in the world coordinate system and the pose of the second object in the world coordinate system based on the further reprojection errors based on the association between the first object and the second object.

18. The apparatus of claim 17, wherein the at least one processor is further configured to:
determine that the second object is not stationary;
disassociate the first object and the second object; and
adjust the pose of the first object in the world coordinate system based on the further reprojection errors.

19. The apparatus of claim 1, wherein the at least one processor is further configured to track the object.

20. The apparatus of claim 1, wherein the at least one processor is further configured to generate virtual content based on the pose of the object in the world coordinate system.

21. A method for tracking objects, the method comprising:
obtaining a pose of an object in a world coordinate system;
obtaining an image of the object from a camera position;
obtaining a world-to-camera transformation for relating the world coordinate system to the camera position;
determining a reprojection error based on the pose of the object in the world coordinate system, the image, and the world-to-camera transformation; and
adjusting the pose of the object in the world coordinate system based on the reprojection error.

22. The method of claim 21, further comprising determining that the object is stationary, wherein adjusting the pose of the object in the world coordinate system is based, at least in part, on determining that the object is stationary.

23. The method of claim 22, wherein the object is determined to be stationary based on one or more of:
respective locations of the object in a plurality of images of the object;
a categorization of the object; or
data from one or more other sensors.

24. The method of claim 21, wherein:
the image comprises a first image;
the camera position comprises a first camera position;
the world-to-camera transformation comprises a first world-to-camera transformation;
the reprojection error comprises a first reprojection error; and
the method further comprises:
obtaining a second image of the object from a second camera position;
obtaining a second world-to-camera transformation for relating the world coordinate system to the second camera position;
determining a second reprojection error based on the pose of the object in the world coordinate system, the second image, and the second world-to-camera transformation; and
adjusting the pose of the object in the world coordinate system based on the second reprojection error.

25. The method of claim 21, further comprising:
determining that the first object is stationary;
obtaining a pose of a second object in the world coordinate system;
determining that the second object is stationary; and
adjusting the pose of the second object in the world coordinate system based on the reprojection error.

26. The method of claim 25, further comprising:
obtain a second image of the first object from a second camera position;
obtain a second world-to-camera transformation for relating the world coordinate system to the second camera position;
determine a second reprojection error based on the pose of the first object in the world coordinate system, the second image, and the second world-to-camera transformation;
adjust the pose of the first object in the world coordinate system based on the second reprojection error; and
adjust the pose of the second object in the world coordinate system based on the second reprojection error.

27. The method of claim 25, further comprising:
associating the first object with the second object based on the first object and the second object being stationary;
determining further reprojection errors based on further poses of the first object in the world coordinate system, further images, and further work-to-camera transformations;
adjusting the pose of the first object in the world coordinate system and the pose of the second object in the world coordinate system based on the further reprojection errors based on the association between the first object and the second object.

28. The method of claim 27, further comprising:
determining that the second object is not stationary;
disassociating the first object and the second object; and
adjusting the pose of the first object in the world coordinate system based on the further reprojection errors.
